(19) United States
(12) Patent Application Publication
(10) Pub. No.: US 2024/0161563 A1
(43) Pub. Date: May 16, 2024

(54) GATE DEVICE, GATE DEVICE CONTROL METHOD, AND COMPUTER-READABLE MEDIUM

(71) Applicant: NEC Corporation, Minato-ku, Tokyo (JP)

(72) Inventors: Osamu SAKAGUCHI, Tokyo (JP); Tomohiro Hafae, Tokyo (JP); Tshirnasa Niya, Tokyo (JP)

(73) Assignee: NEC Corporation, Minato-ku, Tokyo (JP)

(21) Appl. No.: 18/284,423

(22) PCT Filed: Mar. 30, 2021
(86) PCT No.: PCT/JP2021/013453

§ 371 Date: Sep. 27, 2023

(51) Int. Cl. G07C 9/37

(52) U.S. Cl. CPC G07C 9/37

(57) ABSTRACT

The present invention provides a gate device that improves convenience for the user using a gate device that supports two-way traffic. The gate device includes a unit for detecting the party to be authenticated, and a monitor control unit. The unit for detecting the party to be authenticated detects a first user in a prescribed position on one side as a party to be authenticated. The monitor control unit displays on a monitor that a second user on the other side cannot enter the device in response to a server device being requested to authenticate the detected party to be authenticated or in response to the receipt of a successful authentication from the server device.

### TECHNICAL FIELD

The present invention relates to a gate device, a biometric authentication control unit, a system, a method for controlling the gate device, and a storage medium.

### BACKGROUND ART

Services using face authentication have started to spread. For example, face authentication has started to be applied to various procedures (for example, check in, baggage check, security check, and the like) at airports. Alternatively, development of a ticket gate compatible with face authentication is also in progress.

Various technologies related to biometric authentication have been developed.

For example, PTL 1 describes providing an automatic ticket gate system, an automatic ticket gate method, and a program that enable a vulnerable person to use an automatic ticket gate with peace of mind. The station service system of PTL 1 includes an image acquisition unit, a determination processing unit, an identification processing unit, and a setting processing unit. The image acquisition unit acquires a captured image obtained by capturing an image of a user using the automatic ticket gate. The determination processing unit determines whether the captured image acquired by the image acquisition unit includes an image of a vulnerable person. When the determination processing unit determines that the captured image includes the image of the vulnerable person, the identification processing unit identifies a passage to be used that is a ticket gate passage that the vulnerable person intends to use. The setting processing unit permits a vulnerable person to pass in the first direction that is a direction in which the vulnerable person passes for the passage to be used identified by the identification processing unit, and prohibits the person to pass in the second direction opposite to the first direction.

PTL 2 describes providing a door authentication system capable of securing security while improving convenience. The face authentication type locking/unlocking system of PTL 2 performs an authentication process as to whether a person is a resident based on a face image of the person captured by a camera, and performs locking/unlocking control of an entrance door provided at an entrance by a locking/unlocking device based on an authentication result. In the site, a first area adjacent to the entrance and an outside image capturing area outside the first area and included in an imaging range of the camera are set. In this case, when the authentication process is performed based on the face image of the person in the outside image capturing area imaged by the camera, and the person in the outside image capturing area is authenticated as a resident by the authentication process, it is determined whether the resident has moved to the first area. When the resident moves to the first area as a result of the determination, the front door is unlocked by the locking/unlocking device.

### CITATION LIST

### Patent Literature

PTL 1: JP 2020-091516 A
PTL 2: JP 2017-218801 A

### SUMMARY OF INVENTION

### Technical Problem

When biometric authentication is applied to a gate device used by many users, such as a ticket gate installed at a station, a problem may occur. Specifically, a ticket gate installed at a station often supports invasion from both directions by users (passengers). When such a ticket gate is made compatible with face authentication, authentication starts on both sides when persons approaches from both sides. When the authentication results on both sides are “authentication success”, the ticket gate outputs a message or the like to that effect, so that the user who sees the message enters the ticket gate. Alternatively, even when the authentication is not started, if the ticket gate indicates “entry permitted”, the user who has moved in front of the ticket gate enters the ticket gate, which may be an obstacle to the passage of the user for whom the authentication has already been completed.

The problem cannot be solved even by applying the techniques disclosed in PTLs 1 and 2. This is because PTL 1 is a document directed to a vulnerable person, and PTL 2 is not a document directed to a ticket gate.

A main object of the present invention is to provide a gate device, a biometric authentication control unit, a system, a method for controlling the gate device, and a storage medium that contribute to improving convenience of a user who uses the gate device compatible with bidirectional passage.

### Solution to Problem

According to a first aspect of the present invention, there is provided a gate device including an authenticatee detection unit that detects a first user at a predetermined position on one side as an authenticatee, and a monitor control section that displays, on a monitor, that a second user on the other side is not permitted to make an invasion upon the gate device in response to making a request of a server device for authentication of the detected authenticatee or in response to receiving authentication success from the server device.

According to a second aspect of the present invention, there is provided a biometric authentication control unit including an authenticatee detection unit that detects a first user at a predetermined position on one side as an authenticatee, and a request unit that makes a request of a server device that performs biometric authentication for authentication of the detected authenticatee, wherein the authenticatee detection unit transmits a biometric authentication start notification to a gate control unit via a relay unit in response to the biometric authentication being requested, and wherein the relay unit controls a first monitor and a second monitor installed at the gate device.

According to a third aspect of the present invention, there is provided a system including a server device that performs biometric authentication, and a gate device connected to the server device, wherein the gate device includes an authenticatee detection unit that detects a first user at a predetermined position on one side as an authenticatee, and a monitor control section that displays, on a monitor, that a second user on the other side is not permitted to make an invasion upon the gate device in response to making a request of the server device for authentication of the detected authenticatee or in response to receiving authentication success from the server device.

According to a fourth aspect of the present invention, there is provided a method of controlling a gate device, the method including the gate device detecting a first user at a predetermined position on one side as an authenticatee, and displaying, on a monitor, that a second user on the other side is not permitted to make an invasion upon the gate device in response to making a request of a server device for authentication of the detected authenticatee or in response to receiving authentication success from the server device.

According to a fifth aspect of the present invention, there is provided a non-transitory computer-readable storage medium storing a program for causing a computer mounted on a gate device to execute the steps of detecting a first user at a predetermined position on one side as an authenticatee, and displaying, on a monitor, that a second user on the other side is not permitted to make an invasion upon the gate device in response to making a request of a server device for authentication of the detected authenticatee or in response to receiving authentication success from the server device.

### Advantageous Effects of Invention

According to each aspect of the present invention, there are provided a gate device, a biometric authentication control unit, a system, a method for controlling the gate device, and a storage medium that contribute to improving convenience of a user who uses the gate device related to bidirectional passage. The effect of the present invention is not limited to the above. According to the present invention, other effects may be exhibited instead of or in addition to the effect.

### BRIEF DESCRIPTION OF DRAWINGS

FIG. 1 is a diagram for describing an outline of an example embodiment.

FIG. 2 is a diagram illustrating an example of a schematic configuration of an authentication system according to the first example embodiment.

FIG. 3 is a plan view illustrating an example of a schematic configuration of the gate device according to the first example embodiment.

FIG. 4 is a diagram illustrating an example of a configuration of the gate device according to the first example embodiment.

FIG. 5 is a diagram for explaining an operation of the authentication system according to the first example embodiment.

FIG. 6 is a diagram illustrating an example of a processing configuration of the biometric authentication control unit according to the first example embodiment.

FIG. 7 is a diagram illustrating an example of the authenticatee information table according to the first example embodiment.

FIG. 8 is a diagram illustrating an example of the authentication request according to the first example embodiment.

FIG. 9 is a diagram illustrating an example of table information according to the first example embodiment.

FIG. 10 is a diagram illustrating an example of a processing configuration of the relay unit according to the first example embodiment.

FIG. 11 is a diagram illustrating an example of a processing configuration of the gate control unit according to the first example embodiment.

FIG. 12 is a sequence diagram illustrating an example of operation of the gate device according to the first example embodiment.

FIG. 13 is a diagram illustrating an example of a processing configuration of the server device according to the first example embodiment.

FIG. 14 is a diagram illustrating an example of the user information database according to the first example embodiment.

FIG. 15 is a diagram illustrating an example of the authentication state database according to the first example embodiment.

FIG. 16 is a flowchart illustrating an example of an operation of the server device according to the first example embodiment.

FIG. 17 is a sequence diagram illustrating an example of an operation of the authentication system according to the first example embodiment.

FIG. 18 is a diagram for explaining an operation of the gate device according to the first example embodiment.

FIG. 19 is a diagram for explaining an operation of the gate device according to the first example embodiment.

FIG. 20 is a diagram illustrating an example of a configuration of the gate device according to the first modification of the first example embodiment.

FIG. 21 is a diagram illustrating an example of a configuration of the gate device of the second modification according to the first example embodiment.

FIG. 22 is a diagram illustrating an example of a hardware configuration of the biometric authentication control unit according to the present disclosure.

FIG. 23 is a diagram illustrating an example of a processing configuration of the gate device according to a modification of the disclosure of the present disclosure.

### EXAMPLE EMBODIMENT

First, an outline of an example embodiment will be described. The reference numerals in the drawings attached to this outline are attached to each of elements for convenience as an example for assisting understanding, and the description of this outline is not intended to be any limitation. Unless there is a specific reason to the contrary, the block described in each drawing represents not a configuration of a hardware unit but a configuration of a functional unit. Connection lines between blocks in each drawing include both bidirectional and unidirectional lines. The unidirectional arrow schematically indicates a flow of a main signal (data), and does not exclude bidirectionality. In the present specification and the drawings, elements that can be similarly described are denoted by the same reference numerals, and redundant description can be omitted.

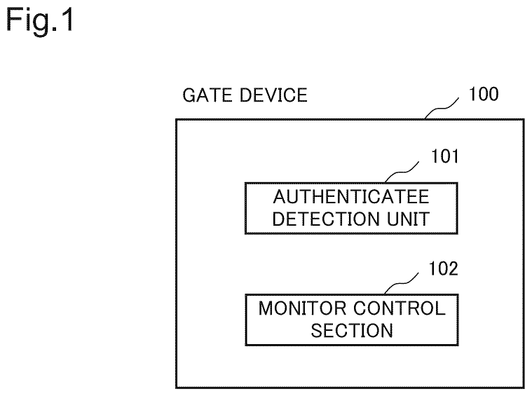

A gate device 100 according to an example embodiment includes an authenticatee detection unit 101 and a monitor control section 102 (see FIG. 1). The authenticatee detection unit 101 detects a first user at a predetermined position on one side as the authenticatee. The monitor control section 102 displays on a monitor that a second user on the other side is not permitted to make an invasion upon the gate device in response to making a request of a server device for authentication of the detected authenticatee or in response to receiving an authentication success from the server device.

Gate device 100 supports entry from both directions like a ticket gate installed in a station or the like. When the user tries to enter the gate device 100 from one side, the gate device 100 makes a request of the server device that performs the biometric authentication for authentication in order to check whether the user has authority to pass the gate device 100. Furthermore, the gate device 100 notifies the user on the other side that the invasion into the gate device 100 is not permitted using the request of the server device for the biometric authentication as a trigger. The user who sees such a notification does not enter the gate device 100. Since the user who has not made the authentication request does not enter the gate device 100, it does not interfere with the user who has started the authentication. As described above, gate device 100 improves the convenience of the user.

Hereinafter, specific example embodiments will be described in more detail with reference to the drawings.

### First Example Embodiment

The first example embodiment will be described in more detail with reference to the drawings.

[System Configuration]

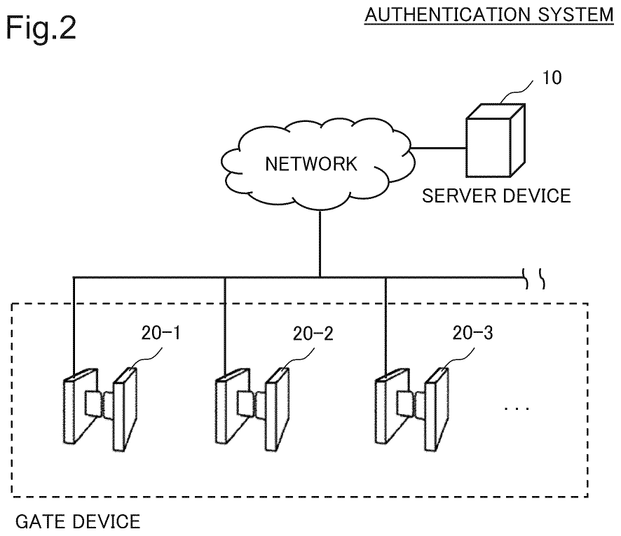

FIG. 2 is a diagram illustrating an example of a schematic configuration of the authentication system according to the first example embodiment. Referring to FIG. 2, the authentication system includes a server device 10 and a plurality of gate devices 20-1 to 20-3.

In the following description, in a case where there is no particular reason to distinguish the gate devices 20-1 to 20-3, they are simply referred to as the “gate devices 20”. Similarly, other configurations are represented by the reference sign left of the hyphen.

The server device 10 and the gate device 20 are configured to be able to communicate with each other by wired or wireless communication means. The server device 10 may be installed in the same building as the gate device 20, or may be installed on a network (cloud).

The server device 10 is a device that controls the entire authentication system. The server device 10 is a device that performs biometric authentication of a user who is about to pass through the gate device 20. When the user is qualified (authorized) to pass through the gate device 20, the server device 10 permits passage of the user. When the user is not qualified to pass through the gate device 20, the server device 10 rejects passage of the user.

The gate device 20 is, for example, a device installed in an airport or a station. The gate device 20 controls passage of a user. The gate device 20 supports passage from both directions. In the first example embodiment, the gate device 20 will be described as a ticket gate installed at a station. However, it is a matter of course that the gate device 20 is not intended to be limited to a ticket gate installed at a station.

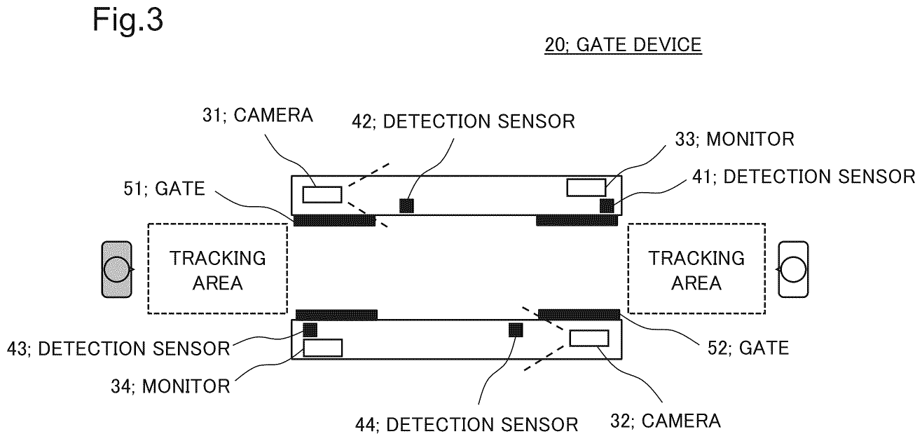

FIG. 3 is a view illustrating an example of a plan view when the gate device 20 is viewed from above. As illustrated in FIG. 3, the gate device 20 includes two cameras 31 and 32. The camera 31 is installed in such a way as to be capable of capturing an image of a user approaching the gate device 20 from the right side. The camera 32 is installed in such a way as to be capable of capturing an image of a user approaching the gate device 20 from the left side.

The gate device 20 includes two monitors 33 and 34. The monitor 33 is installed in such a way as to be visually recognizable by a user walking from the right side. The monitor 34 is installed in such a way as to be visually recognizable by a user walking from the left side. The installation and position of the device (cameras 31 and 32, monitors 33 and 34) illustrated in FIG. 3 are exemplary. For example, the camera 31 and the monitor 33 may be disposed vertically, and the camera 32 and the monitor 34 may be disposed vertically. With such an installation, it is easy for the users to directly face the monitors 33 and 34 and it is easy to obtain an image suitable for biometric authentication.

The gate device 20 includes four detection sensors 41 to 44 for detecting a user who has entered the gate device. Although four detection sensors 41 to 44 are illustrated in FIG. 3, it is a matter of course that the number of detection sensors is not limited.

The gate device 20 includes two gates 51 and 52. The gate 51 is a gate that controls passage of a user walking from the right side. The gate 52 is a gate that controls passage of a user walking from the left side.

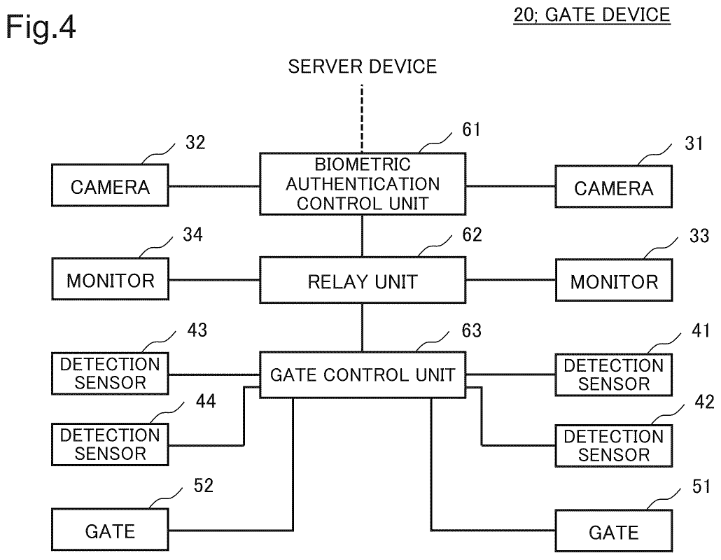

The gate device 20 includes a biometric authentication control unit 61, a relay unit 62, and a gate control unit 63 (see FIG. 4). The biometric authentication control unit 61, the relay unit 62, and the gate control unit 63 are connected by a bus standard such as a Universal Serial Bus (USB) or a peripheral component interconnect (PCI), for example.

The biometric authentication control unit 61 is a unit that can be retrofitted (add-on) to the gate device 20. The biometric authentication control unit 61 is configured to be able to communicate with the cameras 31 and 32. The biometric authentication control unit 61 is connected to the server device 10.

The relay unit 62 is a unit that is connected between the biometric authentication control unit 61 and the gate control unit 63 and relays communication between these units. The relay unit 62 is connected to the monitors 33 and 34. The relay unit 62 controls display of the monitors 33 and 34 based on information (control signal) transmitted and received between the biometric authentication control unit 61 and the gate control unit 63.

The gate control unit 63 is a module that controls the gates 51 and 52. The gate control unit 63 controls opening and closing of the gates 51 and 52 by transmitting a control signal to the gates. The gate control unit 63 uses the detection signal from the detection sensors 41 to 44 for gate control.

[Outline Operation of System]

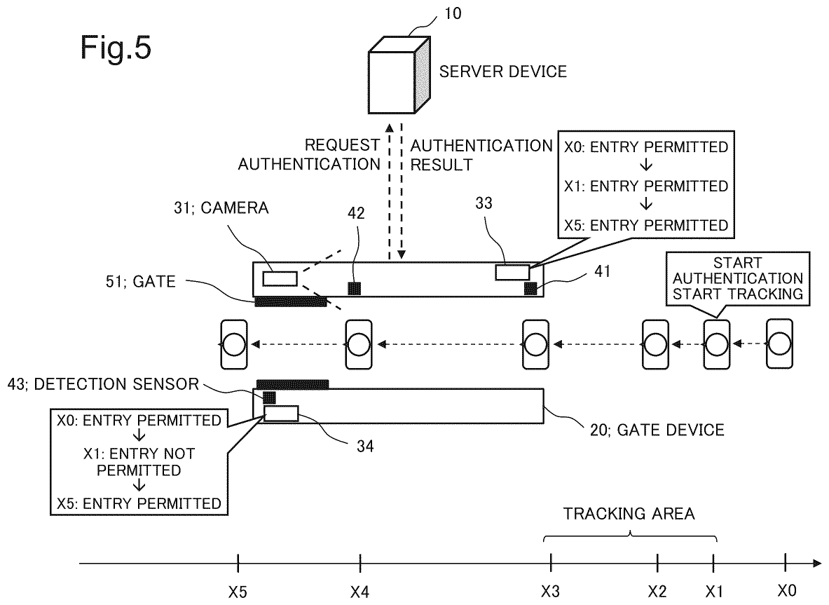

Next, an outline of an operation of the authentication system according to the first example embodiment will be described with reference to the drawings. FIG. 5 is a diagram for describing a schematic operation of the authentication system according to the first example embodiment. An operation in a case where the user approaches the gate device 20 from the right side will be described with reference to FIG. 5. Regarding the operation when the user approaches from the left side of the gate device 20, the left and right sides of the following description may be interchanged, and the description thereof will be omitted. In FIG. 5, a device or the like used when the user passes from the left side such as the gate 52 is not illustrated.

The biometric authentication control unit 61 starts the biometric authentication of the user at a timing when the user approaches the gate device 20 to a predetermined distance. For example, in the examples of FIGS. 3 and 5, when the user reaches the tracking area set on each of left and right of the gate device 20, authentication of the user is started.

In other words, when there is no user around (on both sides of) the gate device 20, the state of the gate device 20 is the initial state. For example, as illustrated in FIG. 5, when the user is outside the tracking area set on each of left and right of the gate device 20 (for example, in a case where the user is located at position X0 in FIG. 5), the state of the gate device 20 is the initial state.

In the initial state, the relay unit 62 displays “entry permitted” on each of the monitors 33 and 34.

When the user approaches the gate device 20, the biometric authentication control unit 61 detects the user at position X1. Thereafter, the biometric authentication control unit 61 requests the server device 10 to perform biometric authentication of the detected user. Specifically, the biometric authentication control unit 61 transmits an “authentication request” including the biometric information of the user to the server device 10.

The biometric authentication control unit 61 starts tracking of the user (the authenticatee detected at position X1) at substantially the same timing as the transmission of the authentication request (the start of authentication).

Further, when transmitting the authentication request to the server device 10, the biometric authentication control unit 61 notifies the gate control unit 63 of the fact. More specifically, the biometric authentication control unit 61 notifies the gate control unit 63 that the authentication request has been transmitted by clearly indicating the side (the right side in the example of FIG. 5) on which the authenticatee (the user who has reached the tracking area) has been detected. In this case, the biometric authentication control unit 61 transmits a “right side biometric authentication start notification” to the relay unit 62. When the biometric authentication is started on the left side, the biometric authentication control unit 61 transmits a “left side biometric authentication start notification” to the relay unit 62. The biometric authentication start notification is transmitted to the gate control unit 63 via the relay unit 62.

As described above, when detecting the authenticatee at position X1, the biometric authentication control unit 61 makes a request of the server device 10 for authentication and starts tracking the authenticatee at substantially the same timing. Further, the biometric authentication control unit 61 notifies the gate control unit 63 via the relay unit 62 that the biometric authentication has been started.

When receiving the biometric authentication start notification, the relay unit 62 clearly indicates that the user is permitted to enter the gate device 20 on the monitor 33 on the side on which the biometric authentication is started (the right side in the example of FIG. 5). For example, the relay unit 62 maintains the message “entry permitted” displayed on the monitor 33.

On the other hand, with respect to the monitor (in the example of FIG. 5, the monitor 34) opposite to the side on which authentication is started, the relay unit 62 clearly indicates that the user is not permitted to enter the gate device 20. For example, the relay unit 62 displays “entry not permitted” on the monitor 34.

The server device 10 that has received the authentication request identifies the user by the collation process (authentication process) using the biometric information registered in advance. The server device 10 determines whether the identified user is qualified to pass through the gate device 20. For example, the server device 10 confirms a recharge amount or the like of the preregistered user, and determines whether the authenticatee is permitted to pass. When determining whether the authenticatee is permitted to pass, the server device 10 may make an inquiry to an external server or the like. Whether to contact an external server or the like depends on the specification, design, and the like of the system, and is different from the gist of the disclosure of the present disclosure, so that the description of the configuration of the system including the external server is omitted.

The server device 10 transmits a response (authentication result) to the authentication request to the biometric authentication control unit 61 that is a transmission source of the request. Specifically, when it is determined that “permitted to pass”, the server device 10 notifies the biometric authentication control unit 61 of “authentication success”. When it is determined as “not permitted to pass”, the server device 10 notifies the biometric authentication control unit 61 of “authentication failure”.

While the server device 10 processes the authentication request, the authenticatee (the person imaged at position X1) moves toward the gate device 20. For example, at the timing when the authenticatee moves to position X2, the biometric authentication control unit 61 receives a response of the authentication request from the server device 10.

Even when the authentication result is received from the server device 10, the biometric authentication control unit 61 continues tracking the authenticatee. Even when receiving the authentication result from the server device 10, the biometric authentication control unit 61 does not instruct the gate control unit 63 to open or close the gate 51 at the timing.

The user (authenticatee) further approaches the gate device 20 and enters the inside thereof (authenticatee reaches position X3). The gate control unit 63 detects that the user enters the gate device 20 based on the detection signal from the detection sensor 41 installed at the entrance of the gate device 20.

When detecting the user, the gate control unit 63 notifies the biometric authentication control unit 61 of the detection. More specifically, the gate control unit 63 notifies the biometric authentication control unit 61 of the detection of the user while clearly indicating the side on which the user is detected. In the example of FIG. 5, gate control unit 63 transmits the “right-side user detection notification” to the relay unit 62. The relay unit 62 transmits the received notification (user detection notification; right user detection notification or left user detection notification) to the biometric authentication control unit 61.

When the fact that the user has entered the gate device 20 is recognized by the notification, the biometric authentication control unit 61 makes a final determination related to tracking of the authenticatee. The biometric authentication control unit 61 makes a final determination on the tracking at the timing (position X3) when it is determined that the user has entered the gate device 20. The biometric authentication control unit 61 determines “tracking completed” when the face tracking of the same person is performed between position X1 and position X3.

When the authentication of the server device 10 is successful and the tracking is completed at the timing when the final determination related to the tracking is made, the biometric authentication control unit 61 determines that the user (authenticatee) is permitted to pass through the gate device 20 and notifies the gate control unit 63 of the determination.

More specifically, the biometric authentication control unit 61 clearly indicates a side on which the user is permitted to pass, and transmits a “passage permission notification” to the gate control unit 63. In the example of FIG. 5, the biometric authentication control unit 61 transmits a “right-side passage permission notification” to the gate control unit 63 via the relay unit 62.

The authenticatee (user) further proceeds from the entrance of the gate device 20 to the inside. When the authenticatee reaches a predetermined position (position X4) of the gate device 20, the gate control unit 63 detects the authenticatee based on a detection signal from the detection sensor 42 installed in the middle of the gate device 20.

When the “passage permission notification” is received at the timing when the user is detected, the gate control unit 63 maintains the open state of the gate 51 to permit the user to pass through the gate.

On the other hand, when the “passage permission notification” is not received at the timing when the user is detected, the gate control unit 63 closes the gate 51 to restrict the passage of the user.

When permitting a plurality of users (authenticatee) to pass through the gate device 20, the biometric authentication control unit 61 transmits “passage permission notifications” related to the number of permitted persons to the gate control unit 63. For example, when two users are permitted to pass, two passage permission notifications are transmitted to the gate control unit 63 via the relay unit 62.

In this case, the gate control unit 63 permits passage for the number of people who have received the notification. The gate control unit 63 closes the gate 51 and rejects passage when users whose number is equal to or more than the number of users notified using the detection sensor 42 try to pass.

When there is no person inside the gate device 20, the gate control unit 63 requests biometric authentication control unit 61 to perform initialization. Specifically, the gate control unit 63 transmits an “initialization request” to the biometric authentication control unit 61 via the relay unit 62. In the example of FIG. 5, when the user reaches the position X5 and the signal from the detection sensors 41 to 44 indicates that no person is present inside the gate device 20, the gate control unit 63 transmits the initialization request.

When receiving the initialization request, the relay unit 62 initializes the display of the monitors 33 and 34. Specifically, the relay unit 62 returns the content displayed on the monitors 33 and 34 to “entry permitted”.

Upon receiving the initialization request, the biometric authentication control unit 61 prepares for new detection of the user (authenticatee) in the tracking areas set on both left and right sides.

When the next user is detected before receiving the initialization request, the biometric authentication control unit 61 transmits a biometric authentication start notification to the relay unit 62 as described above. That is, in a situation where the users sequentially move toward the gate device 20 from one side, the user is not permitted to enter the gate device from the other side. In the example of FIG. 5, the “entry not permitted” on the monitor 34 is not canceled.

When detecting the user in the tracking area on the side opposite to the side where the authenticatee is detected, the biometric authentication control unit 61 does not request the server device 10 to perform the biometric authentication of the user. The biometric authentication control unit 61 does not transmit the authentication request related to the opposite user to the server device 10.

Examples of the biometric information of the user include data (feature amount) calculated from physical features unique to an individual such as a face and an iris pattern. Alternatively, the biometric information of the user may be image data such as a face image and an iris image. The biometric information about the user may include the physical features of the user as information. In the first example embodiment, a person's face image or a feature amount generated from the face image will be described as biometric information.

Various methods are conceivable for tracking the user. For example, in the present disclosure, tracking using a face image and tracking using a body shape image can be used. In the first example embodiment, a case of tracking the authenticatee using face tracking using a face image (face region) will be described.

The configuration illustrated in FIG. 2 and the like is an example and is not intended to limit the configuration of the system. For example, the authentication system may include at least one or more gate devices 20. Each gate device 20 may be installed at the same place (for example, the same station), or may be installed in a different place.

Next, details of the biometric authentication control unit 61, the relay unit 62, the gate control unit 63, and the server device 10 included in the authentication system according to the first example embodiment will be described.

[Biometric Authentication Control Unit]

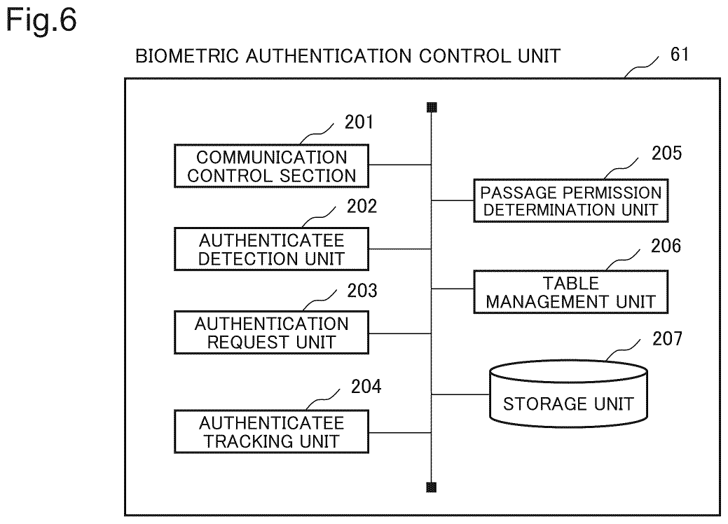

FIG. 6 is a diagram illustrating an example of a processing configuration (processing module) of the biometric authentication control unit 61 according to the first example embodiment. Referring to FIG. 6, the biometric authentication control unit 61 includes a communication control section 201, an authenticatee detection unit 202, an authentication request unit 203, an authenticatee tracking unit 204, a passage permission determination unit 205, a table management unit 206, and a storage unit 207.

The communication control section 201 is a means that controls communication with another apparatus. For example, the communication control section 201 receives data (packet) from the server device 10. The communication control section 201 transmits data to the server device 10. The communication control section 201 delivers data received from another apparatus to another processing module. The communication control section 201 transmits data acquired from another processing module to another apparatus. In this manner, the another processing module transmits and receives data to and from the another apparatus via the communication control section 201.

The communication control section 201 transmits and receives data to and from another device (relay unit 62) via a bus such as a USB.

The authenticatee detection unit 202 is a means that detects the authenticatee. The authenticatee detection unit 202 detects the first user as the authenticatee at a predetermined position on one side of the two entrances of the gate device 20. More specifically, the authenticatee detection unit 202 detects a person at a position (predetermined position) away from the gate device 20 by a predetermined distance as the authenticatee. For example, the authenticatee detection unit 202 detects whether a person is present at a place (position X1 in FIG. 5) away from the gate device 20 by a predetermined distance.

The authenticatee detection unit 202 acquires image data from the camera 31 and the camera 32 periodically or at a predetermined timing. The authenticatee detection unit 202 attempts to extract a face image from each of the acquired image data.

Since an existing technique can be used for the face image extraction process by the authenticatee detection unit 202, detailed description thereof will be omitted. For example, the authenticatee detection unit 202 may extract a face image (face region) from image data by using a training model trained by a convolutional neural network (CNN). Alternatively, the authenticatee detection unit 202 may extract the face image using a method such as template matching.

When the face image is extracted, the authenticatee detection unit 202 calculates an interocular distance from the face image. Specifically, the authenticatee detection unit 202 extracts the left and right eyes from the face image and calculates the length (the number of pixels) of a straight line connecting the extracted eyes.

The authenticatee detection unit 202 performs a threshold value process on the calculated interocular distance, and determines whether the authenticatee is present at the predetermined position (position X1) according to the result. Specifically, when the interocular distance is longer than the threshold value, the authenticatee detection unit 202 determines that the authenticatee has been detected at a predetermined position. When the interocular distance is equal to or less than the threshold value, the authenticatee detection unit 202 determines that the authenticatee is not present at the predetermined position. In this manner, the authenticatee detection unit 202 detects the authenticatee based on the interocular distance calculated from the face image included in the data of an image captured at the predetermined position (position X1).

When the authenticatee is detected at the predetermined position (position X1), the authenticatee detection unit 202 adds an entry to the authenticatee information table. The authenticatee detection unit 202 assigns the authenticatee ID for identifying the authenticatee, and stores the authenticatee ID in a new entry. The authenticatee detection unit 202 also stores the side where the authenticatee is detected (detection side) and the time when the authenticatee is registered in the authenticatee information table (time when a new entry is added) in the authenticatee information table.

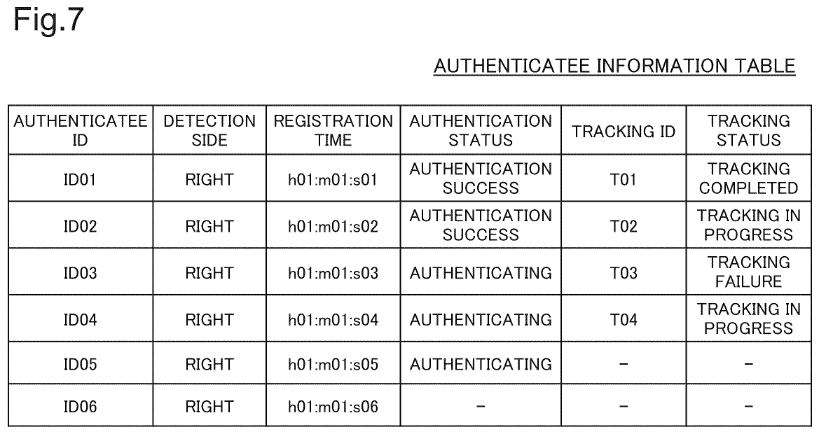

FIG. 7 is a diagram illustrating an example of the authenticatee information table according to the first example embodiment. The authenticatee information table is constructed on the memory of the biometric authentication control unit 61. As illustrated in the lowermost stage of FIG. 7, when detecting a person at position X1 on the right side, the authenticatee detection unit 202 adds an entry to the authenticatee information table and sets the detected person as the authenticatee. Nothing is set in the authentication status field, the tracking ID field, and the tracking status field at the timing when the entry is added.

The authentication status field is a field for managing a status related to biometric authentication of the authenticatee. The tracking ID field is a field for storing a tracking ID to be described later. The tracking status field is a field for managing a tracking status of the authenticatee. In FIG. 7, the case where “left” and “right” are set in the detection side field is described, but instead of “left” and “right”, settings such as the inside of a station (inside of a fence) or the outside of a station structure (outside of a fence) may be set.

When the registration of the authenticatee is completed, the authenticatee detection unit 202 delivers the authenticatee ID and the face image at the time of detecting the authenticatee to the authentication request unit 203 and the authenticatee tracking unit 204. More precisely, the authenticatee detection unit 202 outputs an “authentication request instruction” accompanied by the authenticatee ID and the face image to the authentication request unit 203. The authenticatee detection unit 202 outputs a “tracking start instruction” accompanied by the authenticatee ID and the face image to the authenticatee tracking unit 204.

When the registration of the authenticatee is completed, the authenticatee detection unit 202 transmits a “biometric authentication start notification” to the relay unit 62. When the authenticatee is detected on the right side (when the face image is detected from the image data from the camera 31), the authenticatee detection unit 202 transmits a right biometric authentication start notification to the relay unit 62. When the authenticatee is detected on the left side (when the face image is detected from the image data from the camera 32), the authenticatee detection unit 202 transmits a left biometric authentication start notification to the relay unit 62.

The authentication request unit 203 is a means that requests the server device 10 to authenticate the authenticatee detected by the authenticatee detection unit 202. When the authentication request instruction is received from the authenticatee detection unit 202, the authentication request unit 203 generates a feature amount (a feature vector including a plurality of feature amounts) from the acquired face image.

Since an existing technique can be used for the feature amount generation process, a detailed description thereof will be omitted. For example, the authentication request unit 203 extracts eyes, a nose, a mouth, and the like as feature points from the face image. Thereafter, the authentication request unit 203 calculates the position of each feature point and the distance between the feature points as feature amounts, and generates a feature vector (vector information characterizing the face image) including a plurality of feature amounts.

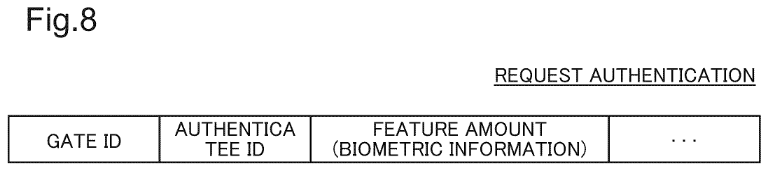

The authentication request unit 203 generates an authentication request including the generated feature amount (biometric information), the authenticatee ID, and the gate ID to transmit the authentication request to the server device 10 (see FIG. 8). The gate ID is identification information for identifying the gate device 20. As the gate ID, a media access control (MAC) address or an Internet protocol (IP) address of the gate device 20 can be used. Alternatively, the gate ID may be system specific identification information (identification ID). Since the server device 10 holds the identification ID as a master, it can be determined that the transmitted authentication request is from the permitted gate device 20.

When the authentication request is transmitted to the server device 10, the authentication request unit 203 sets “authenticating” in the authentication status field of the related entry (entry having the same authenticatee ID) of the authenticatee information table (see the second entry from the bottom of FIG. 7).

The authentication request unit 203 receives a response (a response including an authentication result) to the authentication request from the server device 10. The authentication request unit 203 extracts the authenticatee ID from the received response. The authentication request unit 203 identifies the authenticatee based on the extracted authenticatee ID and registers the authentication result in the related entry of the authenticatee information table (see to first and second entry from upper of FIG. 7).

The authenticatee tracking unit 204 is a means that tracks the authenticatee (the user at position X1) detected by the authenticatee detection unit 202. Upon receiving the tracking start instruction from the authenticatee detection unit 202, the authenticatee tracking unit 204 starts tracking the person related to the acquired face image. The authenticatee tracking unit 204 assigns a “tracking ID” to the face image whose tracking has started and manages the face image being tracked.

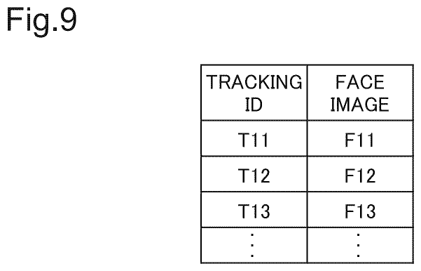

The authenticatee tracking unit 204 manages tracking of the authenticatee using, for example, table information in which a face image and a tracking ID to be tracked are associated as illustrated in FIG. 9.

When the tracking of the authenticatee is started (when the tracking ID is assigned to the face image), the authenticatee tracking unit 204 stores the tracking ID in the tracking ID field of the related authenticatee (the entry related to the authenticatee ID acquired from the authenticatee detection unit 202). The authenticatee tracking unit 204 sets “tracking in progress” in the tracking status field of the related authenticatee (see the third entry from the bottom of FIG. 7).

The authenticatee tracking unit 204 acquires image data from the camera (the camera 31 or 32 on the side on which authentication is started) periodically or at a predetermined timing. The authenticatee tracking unit 204 makes tracking determination of the authenticatee using the acquired image data. Specifically, the authenticatee tracking unit 204 determines “tracking success” when the face image same as the previous face image (for example, the face image at the start of tracking) can be obtained by translation, rotation, and scale in the acquired image data. When such a face image cannot be obtained, the authenticatee tracking unit 204 determines “tracking failure”. Existing processing can be used for the tracking process using the face image, and thus, a further description thereof will be omitted.

The authenticatee tracking unit 204 reflects the result of the tracking determination in the authenticatee information table. Specifically, the authenticatee tracking unit 204 sets the tracking status of the entry related to the tracking ID for which tracking has been determined to be successful among the tracking IDs to be tracked to “tracking in progress”. On the other hand, the authenticatee tracking unit 204 sets the tracking status of the entry related to the tracking ID for which tracking has been determined to fail among the tracking IDs to be tracked to “tracking failure” (see the third entry from the top in FIG. 7).

In this manner, the authenticatee tracking unit 204 overwrites the tracking status of the authenticatee whose tracking has succeeded with “tracking in progress”, and sets “tracking failure” in the tracking status of the authenticatee whose tracking has failed. When the image data is acquired at the timing when another user crosses in front of the authenticatee and the tracking determination is made, the “tracking failure” can be set in the authenticatee information table. In a case where the authenticatee is away from the gate device 20 and moves back, the “tracking failure” may be set. However, even in the entry in which the “tracking failure” is set, the “tracking in progress” is set if the subsequent tracking determination is successful.

The authenticatee tracking unit 204 acquires the “user detection notification” from the gate control unit 63 via the relay unit 62. The authenticatee tracking unit 204 receives a user detection notification (right side user detection notification, left side user detection notification) clearly indicating a side on which the user is detected.

In accordance with the notification, the authenticatee tracking unit 204 acquires image data from the camera (the camera 31 or 32) on the side on which the authenticatee is detected. The authenticatee tracking unit 204 makes tracking determination using the acquired image data. That is, the authenticatee tracking unit 204 makes a final determination related to tracking of the authenticatee (final tracking determination) in response to detection of the entering person by the gate control unit 63.

When the final tracking determination is completed, the authenticatee tracking unit 204 registers the determination result in the authenticatee information table. More specifically, when the final tracking determination is successful, the authenticatee tracking unit 204 sets the tracking status of the entry related to the tracking ID that is successful in determination to “tracking completed” (see the uppermost entry in FIG. 7).

In a case where the final tracking determination fails, the authenticatee tracking unit 204 does not perform any special processing. In the final tracking determination, the authenticatee tracking unit 204 does not set “tracking failure” for the authenticatee whose tracking has failed.

As described above, when the tracking of the authenticatee between position X1 where the authenticatee is detected and position X3 where the authenticatee enters the gate device 20 is successful, the authenticatee tracking unit 204 sets “tracking completed” in the authenticatee information table.

When the final determination related to the tracking of the authenticatee (final tracking determination) is completed, the authenticatee tracking unit 204 notifies the passage permission determination unit 205 of the completion.

The passage permission determination unit 205 is a means configure to determine whether to permit the authenticatee (user) to pass through the gate device 20, and notify the gate control unit 63 of the result. The passage permission determination unit 205 determines whether the authenticatee is permitted to pass through the gate device 20 based on the result of the biometric authentication of the authenticatee by the server device 10 and the result of the tracking determination of the authenticatee at the entrance of the gate device 20. The passage permission determination unit 205 notifies the gate control unit 63 of the determination result via the relay unit 62.

The passage permission determination unit 205 accesses the authenticatee information table at the timing when the authenticatee tracking unit 204 completes the final tracking determination on the authenticatee.

The passage permission determination unit 205 checks the authentication status field and the tracking status field of each entry included in the authenticatee information table. When there is an entry in which the setting value of the authentication status field indicates “authentication success” and the setting value of the tracking status field indicates “tracking completed”, the passage permission determination unit 205 permits the authenticatee to pass through the gate device 20. Specifically, when there is an entry satisfying the above two conditions, the passage permission determination unit 205 notifies the gate control unit 63 that the user is permitted to pass through the gate device 20. Passage permission determination unit 205 transmits a “passage permission notification” to the gate device 20. When the authenticatee is detected on the right side (when “right” is set in the detection side field of the authenticatee information database), a right side passage permission notification is transmitted. When the authenticatee is detected on the left side (when “left” is set in the detection side field of the authenticatee information database), a left passage permission notification is transmitted.

In the example of FIG. 7, since the uppermost entry satisfies the above two conditions, the passage permission determination unit 205 transmits a “right side passage permission notification” to the relay unit 62. As described above, when the final determination related to the tracking of the authenticatee is made in response to the detection of the entering person at the entrance of the gate device 20, the passage permission determination unit 205 determines whether the authenticatee is permitted to pass through the gate device 20. That is, the passage permission determination unit 205 determines whether the authenticatee is permitted to pass through the gate device based on the result of the biometric authentication and the result of the final determination. When the result of the biometric authentication by the server device 10 is authentication success and the result of the final determination of the tracking is success, the passage permission determination unit 205 transmits, to the relay unit 62, a passage permission notification indicating that the authenticatee is permitted to pass through the gate device 20.

When permitting the user (authenticatee) to pass through the gate, the passage permission determination unit 205 deletes the entry that is the basis of the permission. In the example of FIG. 7, the passage permission determination unit 205 deletes the uppermost entry.

As described above, the passage permission determination unit 205 determines whether the user is permitted to pass through the gate based on the setting value of the authentication status field and the setting value of the tracking status field of the authenticatee information table. As described above, the authenticatee detection unit 202 adds an entry to the authenticatee information table when detecting the authenticatee at a predetermined position. Upon receiving the result of the biometric authentication from the server device 10, the authentication request unit 203 sets the received result of the biometric authentication in the authentication status field of the added entry. The authenticatee tracking unit 204 sets the result of the tracking determination in the tracking status field of the added entry.

The passage permission determination unit 205 may receive a “gate closing notification” from the gate device 20. Upon receiving the notification, the passage permission determination unit 205 continues to access the authenticatee information table for a predetermined period, and checks whether an entry satisfying the above two conditions appears (whether there is an entry). When an entry satisfying the above two conditions appears during the predetermined period, the passage permission determination unit 205 permits the authenticatee (user) to pass through the gate. Specifically, when an entry satisfying the above two conditions appears, the passage permission determination unit 205 transmits a “passage permission notification” to the gate device 20.

For example, in a case where an authentication result (authentication success) from the server device 10 is delayed from being reflected in the authenticatee information table due to a network environment or the like between the gate device 20 and the server device 10, the above phenomenon may occur. Alternatively, the above phenomenon can also occur when the authenticatee tries to run through the gate device 20.

When the entry satisfying the above two conditions does not appear even after the lapse of the predetermined period, the passage permission determination unit 205 notifies the station staff (terminal used by the station staff) of the problem occurrence. Alternatively, the passage permission determination unit 205 may output a voice message or the like to the authenticatee in such a way as to go to the station staff.

The table management unit 206 is a means that manages the authenticatee information table. The table management unit 206 accesses the authenticatee information table periodically or at a predetermined timing, and deletes an unnecessary entry.

The table management unit 206 checks the registration time field of each entry and deletes an entry for which a predetermined period has elapsed since the entry was added to the authenticatee information table. That is, the table management unit 206 deletes an entry that does not satisfy the above two conditions (authentication success, tracking completed) even after a predetermined period has elapsed from the registration of the entry.

By such an operation of the table management unit 206, even when the user detected as the authenticatee moves to another place without going to the gate device 20, such an entry of the authenticatee is deleted.

In a case where the entry is deleted, the table management unit 206 may notify the server device 10 or the authenticatee tracking unit 204 of the deletion. The table management unit 206 may notify of the server device 10 the authenticatee ID and cancel the authentication of the related authenticatee. The table management unit 206 may notify the authenticatee tracking unit 204 of the tracking ID and instruct the authenticatee tracking unit 204 to remove the face image related to the tracking ID from the face image to be tracked.

The storage unit 207 is a means that stores information necessary for the operation of the biometric authentication control unit 61.

[Relay Unit]

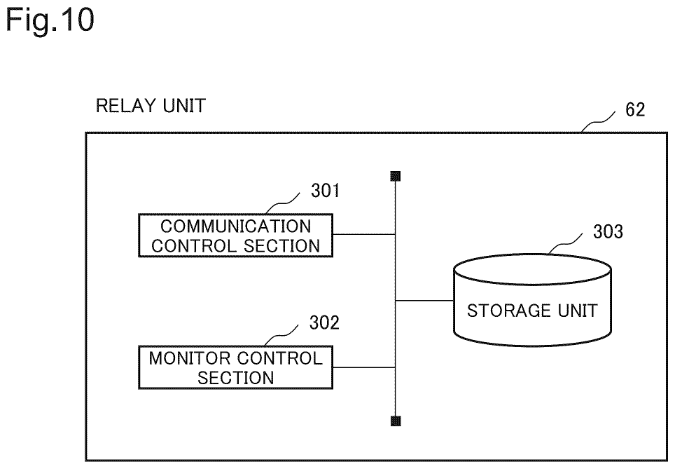

FIG. 10 is a diagram illustrating an example of a processing configuration (processing module) of the relay unit 62 according to the first example embodiment. Referring to FIG. 10, the relay unit 62 includes a communication control section 301, a monitor control section 302, and a storage unit 303.

The communication control section 301 is a means that controls communication with another device (unit). For example, the communication control section 301 receives data from the biometric authentication control unit 61. The communication control section 301 transmits data to the biometric authentication control unit 61. The communication control section 301 delivers data received from another device to another processing module. The communication control section 301 transmits data acquired from another processing module to another device. In this manner, the another processing module transmits and receives data to and from the another device via the communication control section 301.

The communication control section 301 is also a means that transfers data acquired from another apparatus. Specifically, when receiving the biometric authentication start notification or the passage permission notification from the biometric authentication control unit 61, the communication control section 301 transfers these notifications to the gate control unit 63. When receiving the user detection notification or the initialization request from the gate control unit 63, the communication control section 301 transfers these messages to biometric authentication control unit 61.

Monitor control section 302 is a means that controls the monitors 33 and 34 installed at the gate device 20. In response to making a request of the server device 10 for authentication of the authenticatee detected by the biometric authentication control unit 61, the monitor control section 302 displays on the monitor 33 or 34 that the second user on the other side is not permitted to make an invasion upon the gate device 20.

The monitor control section 302 sets the initial display of the monitors 33 and 34 to “entry permitted”. Upon receiving the biometric authentication start notification (right biometric authentication start notification, left biometric authentication start notification) from the biometric authentication control unit 61, the monitor control section 302 displays “entry not permitted” on the monitor opposite to the monitor on the side where the authentication is started according to the notification.

Upon receiving the “initialization request” from the gate control unit 63, the monitor control section 302 initializes the display of the monitors 33 and 34. The monitor control section 302 displays “entry permitted” on the monitors 33 and 34.

As described above, the monitor control section 302 displays that the first user is permitted to entry the gate device 20 on the first monitor (the monitor 33 in the above example) visible to the first user in response to making a request of the server device 10 for authentication of the authenticatee. The monitor control section 302 displays, on a second monitor (for example, the monitor 34) that is visible to a second user (in the above example, the user on the left side), that the second user is not permitted to enter the gate device 20. Further, the monitor control section 302 displays, on left and right monitors 33 and 34, that the users on both sides (one side and the other side) are permitted to enter the gate device 20 in response to the initialization request received when no person is present inside the gate device 20.

The storage unit 303 is a means that stores information necessary for the operation of the relay unit 62.

[Gate Control Unit]

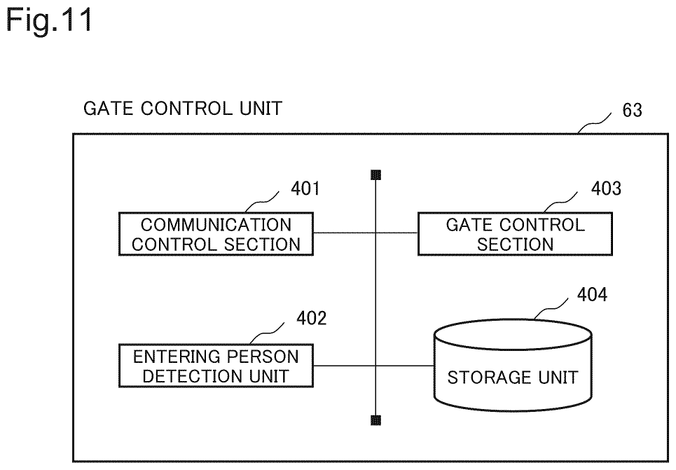

FIG. 11 is a diagram illustrating an example of a processing configuration (processing module) of the gate control unit 63 according to the first example embodiment. Referring to FIG. 11, the gate control unit 63 includes a communication control section 401, an entering person detection unit 402, a gate control section 403, and a storage unit 404.

The communication control section 401 is a means that controls communication with another device (unit). For example, the communication control section 401 receives data from the relay unit 62. The communication control section 401 transmits data to the relay unit 62. The communication control section 401 delivers data received from another device to another processing module. The communication control section 401 transmits data acquired from another processing module to another device. In this manner, the another processing module transmits and receives data to and from another device via the communication control section 401.

The entering person detection unit 402 is a means that detects an entering person to the device (gate device 20). More specifically, the entering person detection unit 402 detects an entering person at the entrance on the side clearly indicated by the biometric authentication start notification. Specifically, the entering person detection unit 402 detects an entering person using a detection signal from the detection sensor 41 or the detection sensor 43. When detecting the entering person, the entering person detection unit 402 transmits a “user detection notification” to the relay unit 62.

When the entering person is detected using the detection signal from the detection sensor 41, the entering person detection unit 402 transmits a “right user detection notification”. When the entering person is detected using the detection signal from the detection sensor 43, the entering person detection unit 402 transmits a “left user detection notification”.

The entering person detection unit 402 detects the user who has reached the intermediate point (position X4 in FIG. 5) of the gate device 20 by using the detection signals from the detection sensors 42 and 44. When detecting the user at position X4, the entering person detection unit 402 notifies the gate control section 403 of the detection of the user while clearly indicating the detected side (right side, left side).

The gate control section 403 is a means that controls the gates 51 and 52 included in the gate device 20. Gate control section 403 controls opening and closing of the gates 51 and 52 at a timing when the user reaches a predetermined position (position X4 in FIG. 5) of the gate device 20.

For example, when the “right-side passage permission notification” has already been received from the biometric authentication control unit 61 at a timing when the user reaches position X4, the gate control section 403 maintains the open state of the gate 51. On the other hand, when the “right-side passage permission notification” is not received from the biometric authentication control unit 61 at the timing, the gate control section 403 closes the gate 51.

In a case where the gate 51 or 52 is closed, the gate control section 403 notifies the biometric authentication control unit 61 of the fact. Specifically, the gate control section 403 transmits a “gate closing notification” to the biometric authentication control unit 61. When receiving the “passage permission notification” during a predetermined period after transmitting the gate closing notification, the gate control section 403 opens closed gates 51 and 52.

The gate control section 403 permits the passage of users whose number is the same as the number of times the passage permission notification is received. For example, when receiving the passage permission notification three times, the gate control section 403 permits three users (authenticatees) to pass. However, the gate control section 403 rejects passage of the fourth user.

After confirming the passage of users whose number is the same as the number of times of the passage permission notification is received, the gate control section 403 checks whether there is a user inside the gate device 20. Specifically, the gate control section 403 determines that “user is present” inside the gate device 20 when at least one of detection sensors 41 to 44 outputs the detection signal.

When there is no user inside the gate device 20, the gate control section 403 transmits an “initialization request” to the relay unit 62.

The gate control section 403 notifies the server device 10 via the biometric authentication control unit 61 of the fact that the authenticatee has passed through the gate 51 or 52. Specifically, when the gate control section 403 has permitted the passage of the user through the gate since the user is detected at position X4 and the passage permission notification is received from the biometric authentication control unit 61, the gate control section notifies the biometric authentication control unit 61 of the permission. The passage permission determination unit 205 of the biometric authentication control unit 61 transmits, to the server device 10, a “gate passage notification” including the authenticatee ID and the gate ID of the gate device 20 described in the entry (entry of the authenticatee information table) that is the basis for transmitting the passage permission notification. That is, the biometric authentication control unit 61 transmits, to the server device 10, the “gate passage notification” including the authenticatee ID of the authenticatee who has passed through the gate 51 or 52 and the gate ID.

The storage unit 404 is a means that stores information necessary for the operation of the gate device 20.

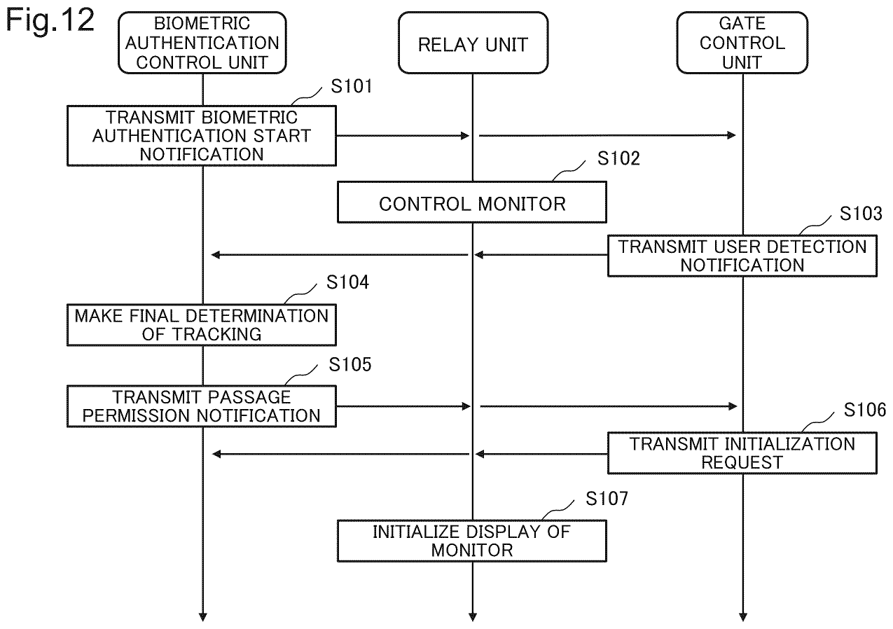

FIG. 12 is a sequence diagram illustrating an example of the operation of the gate device 20 (biometric authentication control unit 61, relay unit 62, gate control unit 63) according to the first example embodiment.

When detecting the user and starting the biometric authentication, the biometric authentication control unit 61 transmits a “biometric authentication start notification” to the relay unit 62 (step S101).

The relay unit 62 controls the monitors 33 and 34 in response to the reception of the biometric authentication start notification (step S102). The relay unit 62 displays “entry not permitted” on the monitor 33 or 34 opposite to the counterpart monitor on the side where the user is detected. In this manner, in response to receiving the biometric authentication start notification by the relay unit 62, the monitor 33 (first monitor) displays that the user (first user) is permitted to enter the gate device 20. The monitor 34 (second monitor) displays that a user (second user) on the other side is not permitted to make an invasion upon the gate device 20.

When the gate control unit 63 detects that the user enters the gate device 20 using the detection sensors 41 and 43, the gate control unit 63 transmits a user detection notification to the relay unit 62 (step S103).

Upon receiving the user detection notification via the relay unit 62, the biometric authentication control unit 61 makes a final determination of tracking of the authenticatee (step S104).

When the passage of the authenticatee through the gate device 20 is permitted based on the authentication result from the server device 10 and the final determination result of the tracking, the biometric authentication control unit 61 transmits a passage permission notification to the relay unit 62 (step S105).

When the gate control unit 63 checks passage of a user permitted to pass through the gate device 20, and no person is present inside the gate device 20, the gate control unit 63 transmits an initialization request to the relay unit 62 (step S106).

The relay unit 62 initializes display content of the monitors 33 and 34 in response to the initialization request (step S107). Specifically, the relay unit 62 displays “entry permitted” on the monitors 33 and 34.

[Server Device]

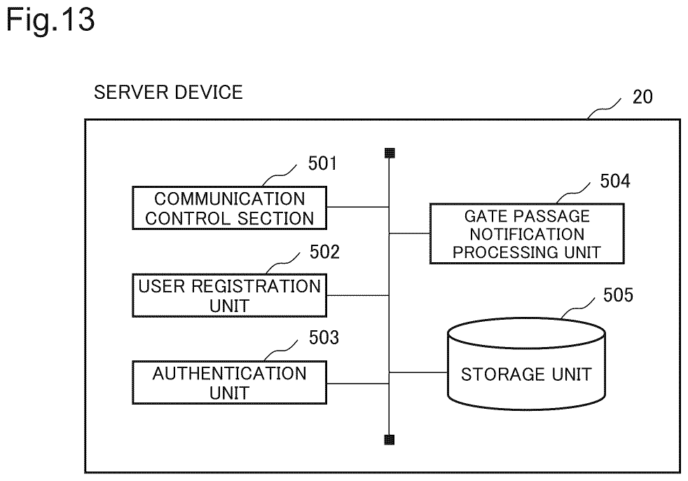

FIG. 13 is a diagram illustrating an example of a processing configuration (processing module) of the server device 10 according to the first example embodiment. Referring to FIG. 13, the server device 10 includes a communication control section 501, a user registration unit 502, an authentication unit 503, a gate passage notification processing unit 504, and a storage unit 505.

The communication control section 501 is a means that controls communication with another apparatus. For example, the communication control section 501 receives data (packet) from the biometric authentication control unit 61. The communication control section 501 transmits data to the biometric authentication control unit 61. The communication control section 501 delivers data received from another apparatus to another processing module. The communication control section 501 transmits data acquired from another processing module to another apparatus. In this manner, the another processing module transmits and receives data to and from the another apparatus via the communication control section 501.

The user registration unit 502 is a means that performs system registration of a user who is permitted to pass through the gate device 20. The user registration unit 502 acquires biometric information (for example, a face image) of a user who is permitted to pass through the gate device 20 using an any means.

For example, the system user inputs biometric information and personal information (name, address, etc.) to the server device 10 using a web (WEB) page of a railway company or a kiosk terminal installed at a station.

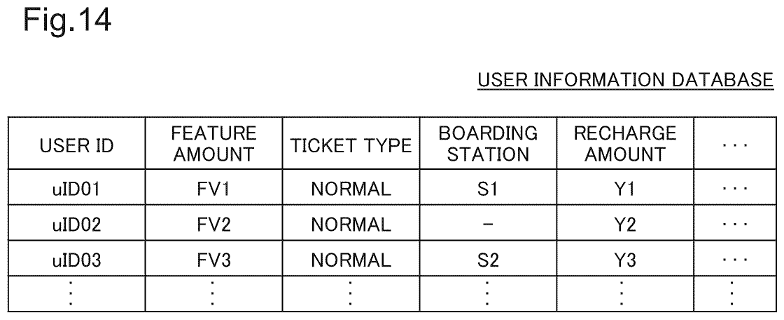

When acquiring a face image, the user registration unit 502 calculates a feature amount from the face image. The user registration unit 502 registers the biometric information (for example, the feature amount calculated from the face image) of the user together with the user ID for identifying the system user (the registrant of the biometric information) in the “user information database” (see FIG. 14).

The user registration unit 502 registers information (operation information) necessary for the authentication process of the user in the user information database as necessary. For example, in a case where the server device 10 processes an authentication request from a ticket gate (gate device 20) installed at a station, the user registration unit 502 stores information such as a recharge amount and biometric information in the user information database in association with each other.

The user information database illustrated in FIG. 14 is an example, and other items may be stored in association with the biometric information (feature amount). For example, the user's name or face image may be registered in the user information database.

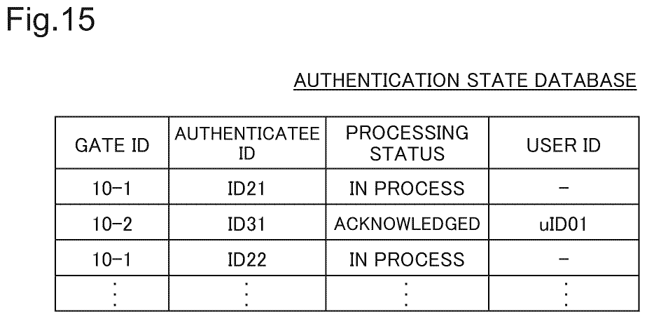

The authentication unit 503 is a means that processes the authentication request received from the biometric authentication control unit 61 (gate device 20). Upon receiving the authentication request, the authentication unit 503 extracts the gate ID and the authenticatee ID from the authentication request. The authentication unit 503 adds a new entry to the authentication state database and stores the extracted gate ID and the extracted authenticatee ID (see FIG. 15). The authentication unit 503 sets the processing status of the additionally written entry to “in process”. In FIG. 15, for easy understanding, the gate ID is denoted by a reference sign of the gate device 20.

When the information is registered in the authentication state database, the authentication unit 503 sets the biometric information (feature amount) included in the authentication request as the collation target, and performs the collation process with the biometric information registered in the user information database.

More specifically, the authentication unit 503 sets the feature amount extracted from the authentication request as the collation target, and performs one-to-N (N is a positive integer, and the same applies hereinafter) collation with the plurality of feature amounts registered in the user information database.

The authentication unit 503 calculates degree of similarity between the feature amount (feature vector) to be collated and each of the plurality of feature amounts on the registration side. A chi-square distance, a Euclidean distance, or the like can be used as the degree of similarity. The longer the distance is, the lower the degree of similarity is, and the distance is the shorter, the higher the degree of similarity is.

When the feature amount the degree of similarity of which is greater than or equal to the predetermined value is not registered in the user information database, the authentication unit 503 sets “authentication failure” for the authentication result.

When the feature amount the degree of similarity of which is greater than or equal to the predetermined value is registered in the user information database, the authentication unit 503 determines whether the user identified by the collation process is qualified to pass through the gate device 20.

For example, in a case where the authentication request received from the gate device 20 for entering the station is processed, the authentication unit 503 determines whether the recharge amount of the identified user is a balance equal to or more than the minimum fare. When the balance of the recharge amount is equal to or smaller than the minimum fare, the authentication unit 503 determines that the identified user is not qualified to pass through the gate device 20. When the balance of the recharge amount is greater than the minimum fare, the authentication unit 503 determines that the identified user is qualified to pass through the gate device 20.

For example, when an authentication request received from the gate device 20 for leaving a station is processed, the authentication unit 503 determines whether a boarding station is set for the identified user. When the boarding station is not set, the authentication unit 503 determines that the identified user is not qualified to pass through the gate device 20. When the boarding station is set, the authentication unit 503 calculates the fare according to the route of the user (the route between the boarding station and the alighting station). When the calculated fare exceeds the recharge amount, the authentication unit 503 determines that the user is not qualified to pass through the gate device 20. When the calculated fare is equal to or less than the recharge amount, the authentication unit 503 determines that the identified user is qualified to pass through the gate device 20.

When the identified user is not qualified to pass through the gate device 20, the authentication unit 503 sets “authentication failure” for the authentication result.

In a case where the identified user is qualified to pass through the gate device 20, the authentication unit 503 sets “authentication success” for the authentication result.

The authentication unit 503 transmits the authentication result (authentication success, authentication failure) to the biometric authentication control unit 61 (gate device 20). In the case of authentication success, the authentication unit 503 transmits a positive acknowledgement indicating authentication success to the biometric authentication control unit 61. At this time, the authentication unit 503 transmits a positive acknowledgement including the authenticatee ID of the user who is to be authenticated to the biometric authentication control unit 61.

In the case of the authentication failure, the authentication unit 503 transmits a negative acknowledgement indicating the authentication failure to the biometric authentication control unit 61. In a case where a negative acknowledgement is transmitted, the authentication unit 503 may notify the biometric authentication control unit 61 of the cause of the authentication failure. For example, the authentication unit 503 may transmit, to the biometric authentication control unit 61, a factor related to the authentication failure such as the biometric information being not registered in the system, the recharge amount being insufficient, the boarding station not being set, or the like. When the authentication fails, the authentication unit 503 transmits a negative acknowledgement including the authenticatee ID of the user who is to be authenticated to the biometric authentication control unit 61.

When an acknowledgement to the authentication request is transmitted to the gate device 20, authentication unit 503 sets “acknowledged” in the entry of the related authentication state database. When the gate device 20 is notified of the authentication success, authentication unit 503 sets the user ID of the authentication successful person (the user determined to be the authentication success) for the user ID of the related entry.

The gate passage notification processing unit 504 is a means that processes the gate passage notification received from the gate device 20 (biometric authentication control unit 61). The gate passage notification processing unit 504 extracts the gate ID and the authenticatee ID from the received notification. The gate passage notification processing unit 504 searches the authentication state database using the gate ID and the authenticatee ID as keys, and identifies a related entry.

The gate passage notification processing unit 504 reads the user ID from the user ID field of the identified entry. The gate passage notification processing unit 504 searches the user information database using the read user ID as a key, and identifies a related entry.

The gate passage notification processing unit 504 performs a process accompanying the gate passage of the user for the identified entry.

For example, in a case where the gate passage notification received from the gate device 20 for entering the station is processed, the gate passage notification processing unit 504 sets the station where the gate device 20 is installed for the boarding station of the identified entry.

For example, when processing the gate passage notification received from the gate device 20 for exiting the station, the gate passage notification processing unit 504 calculates the fare of the user and subtracts the fare from the recharge amount. The gate passage notification processing unit 504 clears the setting value of the boarding station field.

The storage unit 505 stores various types of information necessary for the operation of the server device 10. In the storage unit 505, a user information database and an authentication state database are constructed.

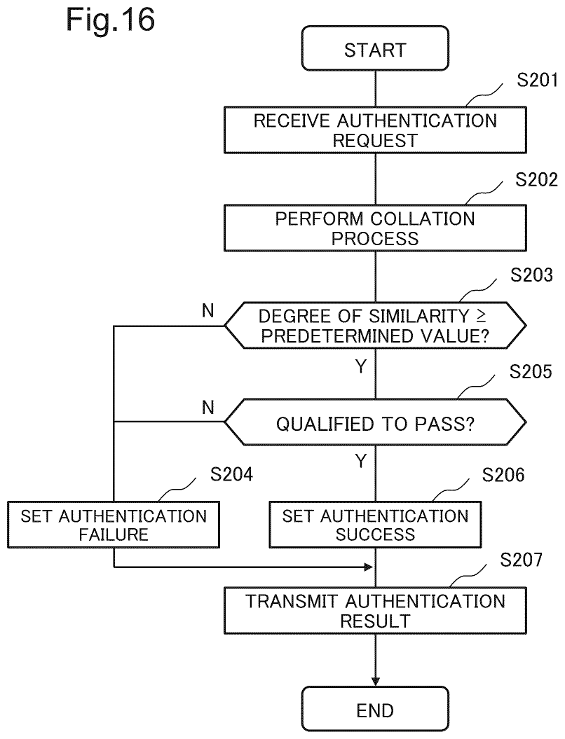

FIG. 16 is a flowchart illustrating an example of the operation of the server device 10 according to the first example embodiment.

The server device 10 receives the authentication request from the biometric authentication control unit 61 (step S201).

The server device 10 performs the collation process using the biometric information included in the authentication request and the biometric information registered in the user information database (step S202).

The server device 10 determines whether there is an entry in which the degree of similarity between the pieces of biometric information is equal to or greater than a predetermined value (step S203).

When such an entry does not exist (step S203: No branch), the server device 10 sets the authentication result to authentication failure (step S204).

When such an entry exists (step S203: Yes branch), the server device 10 determines whether the authenticatee is qualified to pass through the gate device 20 (step S205).

When the authenticatee is not qualified to pass through the gate device 20 (step S205: No branch), the server device 10 sets the authentication result to authentication failure (step S204).

When the authenticatee is qualified to pass through the gate device 20 (step S205: Yes branch), the server device 10 sets the authentication result to authentication success (step S206).

The server device 10 transmits the authentication result (authentication success, authentication failure) to the biometric authentication control unit 61 (step S207).

The description of the operation of the server device 10 when the gate passage notification is received is omitted.

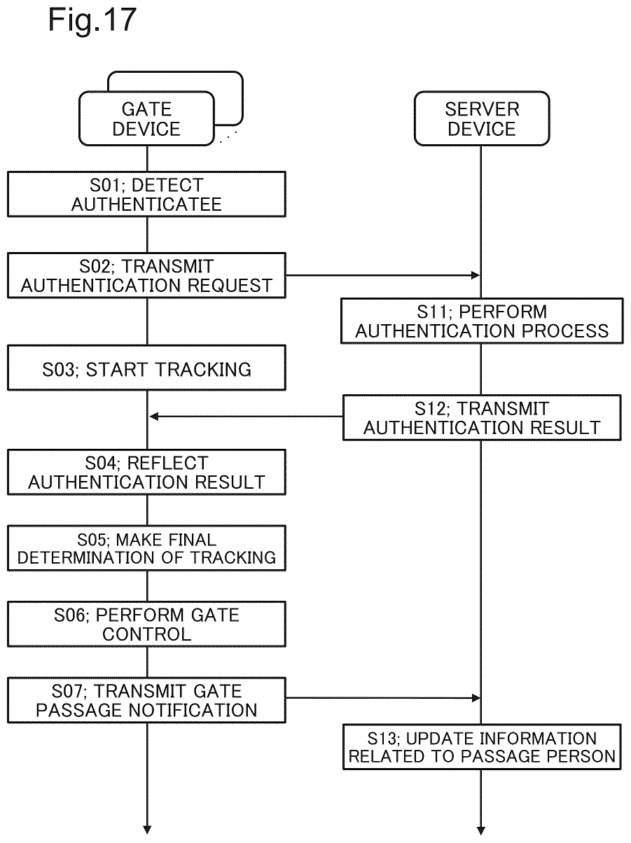

Next, an operation of the authentication system according to the first example embodiment will be described with reference to the drawings. FIG. 17 is a sequence diagram illustrating an example of the operation of the authentication system according to the first example embodiment. It is assumed that the system user is registered in advance prior to the operation of FIG. 17.

The gate device 20 detects the authenticatee at a place away from the gate device 20 by a predetermined distance (step S01).

The gate device 20 acquires the biometric information of the authenticatee to transmit an authentication request including the biometric information to the server device 10 (step S02).

At substantially the same timing as the transmission of the authentication request, that is, at the same time as the server device 10 is requested to authenticate the authenticatee, the gate device 20 starts tracking the authenticatee (step S03).

The server device 10 performs the authentication process to transmit the result to the gate device 20 (steps S11 and S12).

The gate device 20 receives the authentication result, and reflects the authentication result in the authenticatee information table (reflection of the authentication result; step S04).

When the authenticatee reaches the entrance of the gate device 20, the gate device 20 makes a final determination of tracking of the authenticatee (step S05). The gate device 20 reflects the final determination result in the authenticatee information table.

When the authenticatee reaches the predetermined position of the gate device 20, the gate device 20 performs gate control (step S06). Specifically, the gate device 20 permits the passage of the authenticatee set as authentication success and tracking completed.

When the passage of the authenticatee is permitted, the gate device transmits a gate passage notification to the server device 10 (step S07).

When the gate passage notification is received, the server device updates the information about the gate passage person (authentication successful person; the authenticatee determined to be authenticated successfully) (step S13). Specifically, the server device 10 updates the entry of the user information database related to the gate passage person.

Subsequently, a specific operation of the gate device 20 assuming various movements of a user (authenticatee, user not to be authenticated) will be described with reference to the drawings.

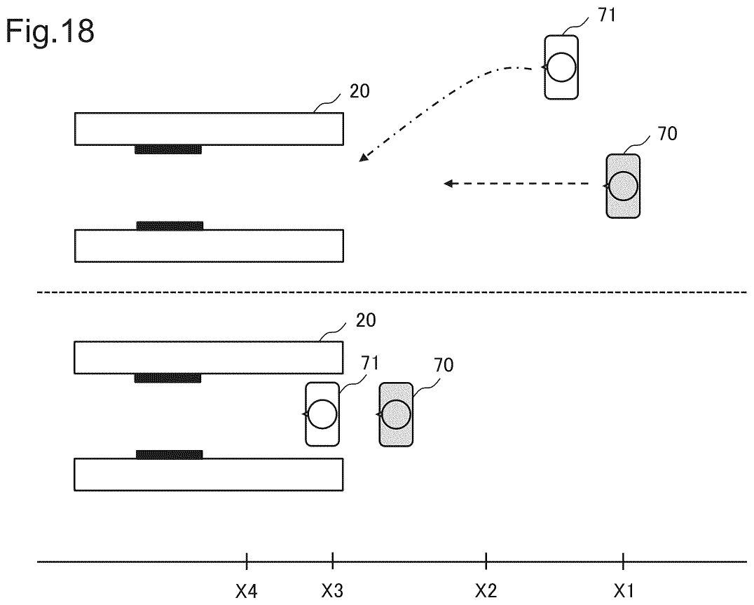

As illustrated in the upper part of FIG. 18, a user 70 is set as an authenticatee, and a user 71 is a user who is not to be authenticated. In the drawings including FIG. 18, the authenticatee is illustrated in gray, and the user who is not to be authenticated is illustrated in white. Since the user 71 is not detected as an authenticatee at position X1, the user 71 is not the authenticatee. Therefore, the entry related to the user 71 does not exist in the authenticatee information table.

The user 70 walks toward the gate device 20. The user 71 moves in such a way as to enter the gate device 20 from the side of user 70. In this case, as time passes, the positional relationship between the two is as illustrated in the lower part of FIG. 18.

Since the entry of the user 71 is not registered in the authenticatee information table, the gate 51 is closed when the user 71 reaches position X4. Even when a predetermined period elapses after the gate 51 is closed, the authentication result of the user 71 is not registered in the authenticatee information table, and thus the gate 51 is not opened.

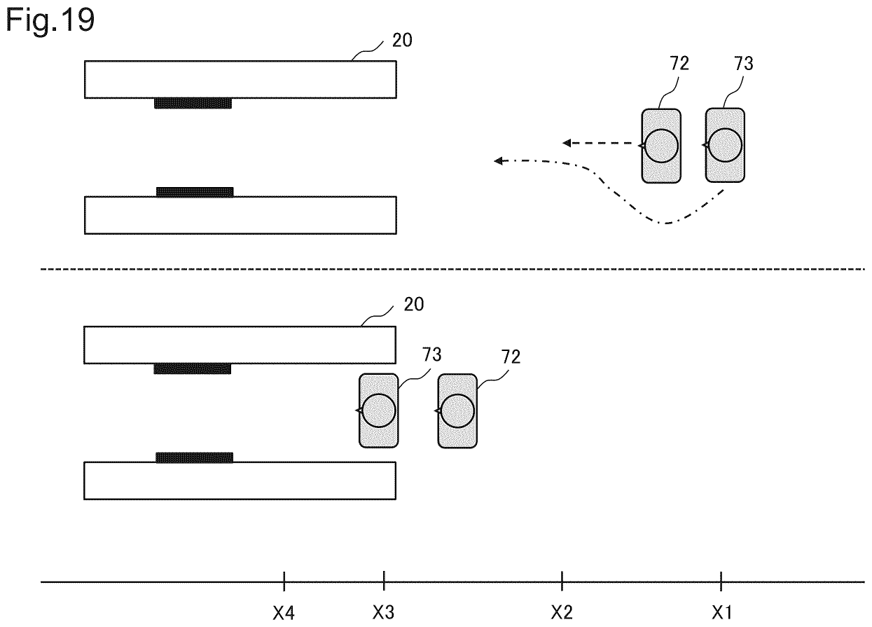

Alternatively, it is also conceivable that the authenticatee overtakes another authenticatee walking in front of the authenticatee. For example, as illustrated in the upper part of FIG. 19, a case where a user 72 and a user 73 walk toward the gate device 20 is considered. In this case, both the user 72 and the user 73 are set as the authenticatees (gray persons) since the biometric information is acquired at position X1 and the tracking is started.

The user 73 walking behind moves as indicated by an alternate long and short dash line in the upper part of FIG. 19 and overtakes the user 72 in front of the user 73. In this case, as time passes, the positional relationship between the two is as illustrated in the lower part of FIG. 19.

The entries of the user 72 and the user 73 are registered in the authenticatee information table, and when the authentication process of the user 73 (the authentication process in the server device 10) is successful, the gate 51 maintains the open state even when the user 73 reaches position X4. Even when the user 72 reaches position X4 following the user 73, the gate 51 is not closed.

In this way, the biometric information is acquired at position X1, and the user set as the authenticatee is normally processed without reaching (entering) the gate device 20 in the set order. That is, the user is permitted to pass through the gate device 20 even when the user does not reach the gate device 20 in the order registered as the authenticatee due to a difference in the gait speed of the authenticatee or the like. As described above, since the authentication system according to the first example embodiment also permits an irregular situation, the throughput of the system is improved.

### First Modification According to First Example Embodiment

In the above example embodiment, the case where the relay unit 62 is provided between the biometric authentication control unit 61 and the gate control unit 63, and the relay unit 62 controls the monitors 33 and 34 is described. However, the gate control unit 63 may control the monitors 33 and 34.

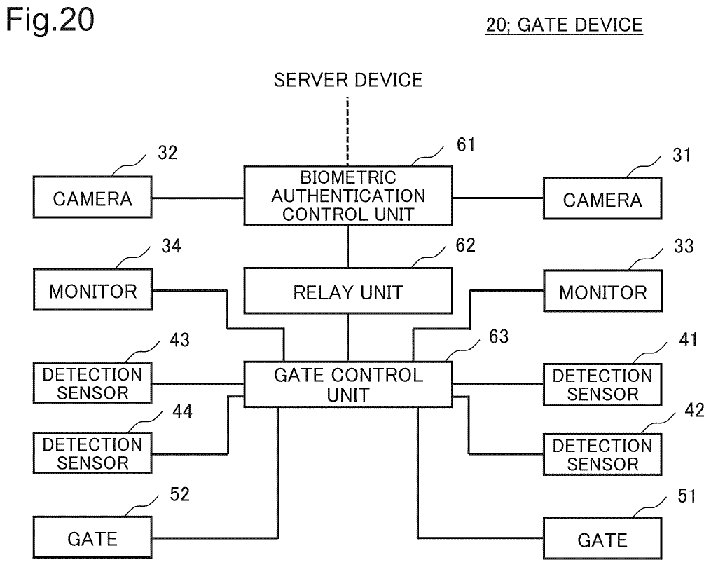

For example, the gate device 20 may have a configuration as illustrated in FIG. 20. Referring to FIG. 20, the monitors 33 and 34 are connected to the gate control unit 63. The gate control unit 63 is only required to include the monitor control section 302 included in the relay unit 62.

When receiving the biometric authentication start notification from the biometric authentication control unit 61 via the relay unit 62, the monitor control section 302 of the gate control unit 63 displays “entry not permitted” on the monitor opposite to the monitor on the side where the authentication is started according to the notification.

When the “initialization request” is transmitted, the monitor control section 302 initializes the display of the monitors 33 and 34. The monitor control section 302 displays “entry permitted” on the monitors 33 and 34.

In this manner, the gate control unit 63 may control the display of the monitors 33 and 34.

### Second Modification According to First Example Embodiment

In the above example embodiment, the case where the relay unit 62 is provided between the biometric authentication control unit 61 and the gate control unit 63, and the relay unit 62 controls the monitors 33 and 34 is described. However, the gate device 20 may not include the relay unit 62.

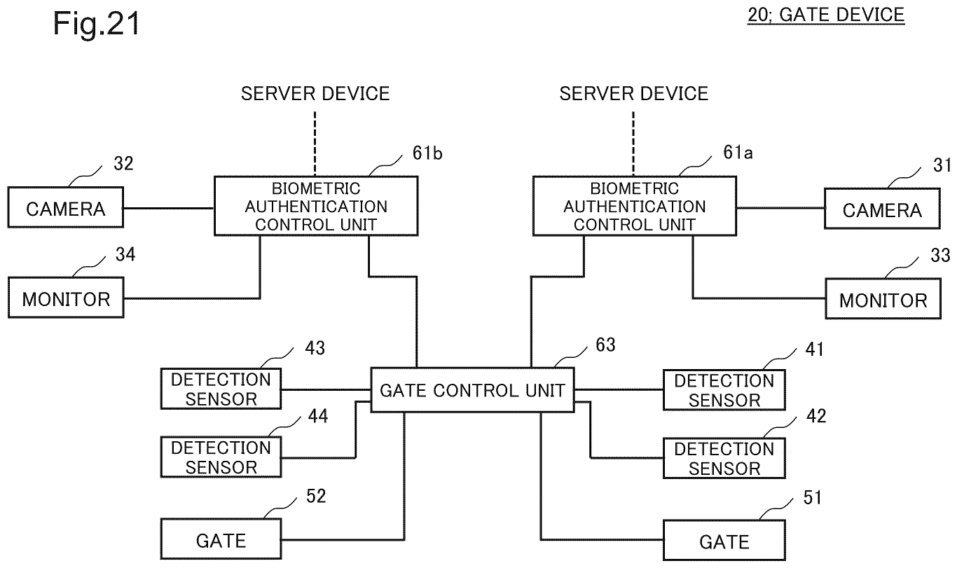

For example, the gate device 20 may have a configuration as illustrated in FIG. 21. Referring to FIG. 21, the gate device 20 includes biometric authentication control units 61a and 61b. The biometric authentication control unit 61a is connected to the camera 31 and the monitor 33. The biometric authentication control unit 61a is a module that performs biometric authentication of the user walking from the right side.

The biometric authentication control unit 61b is connected to the camera 32 and the monitor 34. The biometric authentication control unit 61b is a module that performs biometric authentication of the user walking from the left side.

Each of the biometric authentication control units 61a and 61b is connected to the gate control unit 63 that controls the gates 51 and 52. Each of the biometric authentication control units 61a and 61b is connected to the server device 10.

In the gate device 20 illustrated in FIG. 21, when there are no users on both sides of the gate device 20, the gate device 20 is in the initial state. In this case, each of the biometric authentication control units 61a and 61b displays “entry permitted” of the monitors 33 and 34.

When the user reaches the tracking area set on the side where each of the biometric authentication control units 61a and 61b is responsible for the biometric authentication, each of the biometric authentication control units transmits an authentication request including biometric information (for example, a face image) of the user to the server device 10. When transmitting the authentication request to the server device 10, the biometric authentication control units 61a and 61b notify the gate control unit 63 of the fact. Specifically, each of the biometric authentication control units 61a and 61b transmits a “biometric authentication start notification” to the gate control unit 63.

Gate control unit 63 recognizes whether the biometric authentication is started on the right side or the left side based on the transmission source address or the like of the biometric authentication start notification. The gate control unit 63 notifies the other biometric authentication control unit 61a, 61b for which the biometric authentication is not started of the start of the biometric authentication.

The biometric authentication control units 61a and 61b that have received the notification from the gate control unit 63 display “entry not permitted” on the monitors 33 and 34 connected thereto, respectively. The biometric authentication control unit 61a, 61b on the side where the notification is received does not request the server device 10 to perform the biometric authentication of the user even if the user enters the tracking area.

As described in the first example embodiment, the biometric authentication control units 61a and 61b and the server device 10 perform biometric authentication of the authenticatee and make tracking determination and the like. When permitting the passage of the user, each of the biometric authentication control units 61a and 61b transmit a “passage permission notification” to the gate control unit 63. When the gate control unit 63 confirms passage of persons of the number of persons who have received the notification, and there is no person inside the gate device 20, the gate control unit 63 transmits an “initialization request” to two biometric authentication control units 61a and 61b. Each of the biometric authentication control units 61a and 61b that have received the initialization request initializes the display on the monitors 33 and 34 to display “permitted to pass”.

### Third Modification According to First Example Embodiment

In the above example embodiment, the case where the relay unit 62 controls the display of the monitors 33 and 34 based on the signal transmitted and received between the biometric authentication control unit 61 and the gate control unit 63 is described. However, the control of the monitor 33 and the monitor 34 may be performed based on a clear instruction from the gate control unit 63.

For example, when receiving the “biometric authentication start notification” from the biometric authentication control unit 61, the gate control unit 63 designates a monitor on the side on which “entry not permitted” is displayed among the monitors 33 and 34 to transmit a “monitor control instruction” to the relay unit 62.

The relay unit 62 displays “entry not permitted” on the monitor on the instructed side among the monitors 33 and 34 based on the received monitor control instruction.

When no person is present inside the gate device 20, the gate control unit 63 transmits a “monitor initialization instruction” to the relay unit 62.

The relay unit 62 sets the display on the monitors 33 and 34 to “permitted to pass” based on the received monitor initialization instruction.

### Fourth Modification According to First Example Embodiment

In the second modification, the configuration including the biometric authentication control units 61a and 61b and the gate control unit 63 is described with reference to FIG. 21. In this configuration, the display control of the monitors 33 and 34 may be performed by communication between the two biometric authentication control units 61a and 61b. In this case, in the configuration of FIG. 21, the biometric authentication control units 61a and 61b need to be connected and set to be able to communicate with each other.

When transmitting the authentication request to the server device 10, any of the biometric authentication control unit 61a, 61b notifies the gate control unit 63 and the other biometric authentication control unit 61a, 61b of the fact. Specifically, any of the biometric authentication control units 61a, 61b transmits “biometric authentication start notification” to the gate control unit 63 and the other biometric authentication control units 61a, 61b.

The biometric authentication control units 61a and 61b that have received the biometric authentication start notification display “entry not permitted” on the monitors 33 and 34, respectively, connected thereto. The biometric authentication control unit 61a, 61b on the side where the notification is received does not request the server device 10 to perform the biometric authentication of the user even if the user enters the tracking area.

As described in the first example embodiment, the biometric authentication control units 61a and 61b and the server device 10 perform biometric authentication of the authenticatee and make tracking determination and the like. When permitting the passage of the user, each of the biometric authentication control units 61a and 61b transmit a “passage permission notification” to the gate control unit 63. When the gate control unit 63 confirms passage of persons of the number of persons who have received the notification, and there is no person inside the gate device 20, the gate control unit 63 transmits an “initialization request” to two biometric authentication control units 61a and 61b. Each of the biometric authentication control units 61a and 61b that have received the initialization request initializes the display on the monitors 33 and 34 to display “permitted to pass”.

As described above, in the first example embodiment, when the biometric authentication is started on one side in the gate device 20 capable of passing in both directions, the user is notified that the biometric authentication cannot be used on the other side (that the user is not permitted to enter the gate device 20). The biometric authentication is started when the user is detected in the tracking area (buffer area) set in front of the gate device 20. The gate device 20 permits the passage through the gate when the tracking in the tracking area is completed (the tracking is successful until the user enters the gate device) and the authentication result by the server device 10 is successful. As a result, since the user recognizes the situation of the gate device 20 that the user is about to enter, the user can head to another gate device 20 while avoiding the gate device 20 displaying “not permitted to pass”. Since an unnecessary authentication request is not transmitted to the server device 10, the load on the server device 10 can be reduced.

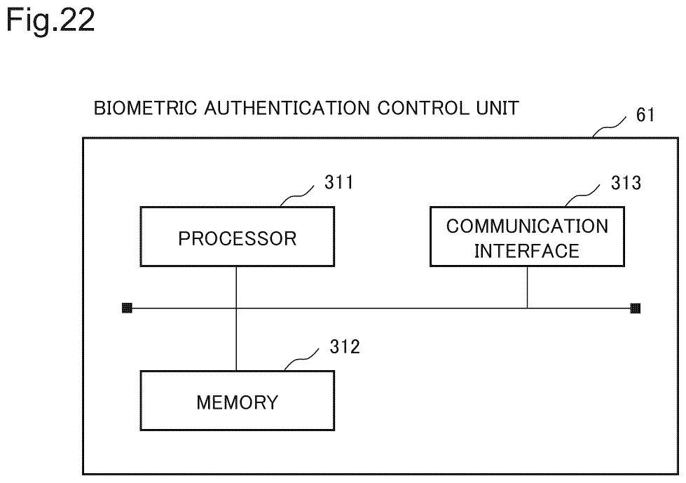

Next, hardware of each device constituting the authentication system will be described. FIG. 22 is a diagram illustrating an example of a hardware configuration of the biometric authentication control unit 61.

The biometric authentication control unit 61 includes a processor 311, a memory 312, a communication interface 313, and the like. The components such as the processor 311 are connected by an internal bus or the like and are configured to be able to communicate with each other.

However, the configuration illustrated in FIG. 22 is not intended to limit the hardware configuration of the biometric authentication control unit 61. The biometric authentication control unit 61 may include another hardware (not illustrated). The number of processors 311 and the like included in the biometric authentication control unit 61 is not limited to the example of FIG. 22, and for example, a plurality of processors 311 may be included in the biometric authentication control unit 61.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various kinds of programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The communication interface 313 is a circuit, a module, or the like that communicates with another apparatus. For example, the communication interface 313 includes a network interface card (NIC), a bus controller, and the like.

The function of the biometric authentication control unit 61 is implemented by various processing modules. The processing module is implemented, for example, by the processor 311 executing a program stored in the memory 312. The program can be recorded in a computer-readable storage medium. The storage medium may be a non-transient medium such as a semiconductor memory, a hard disk, a magnetic recording medium, or an optical recording medium. That is, the present invention can also be embodied as a computer program product. The program can be downloaded via a network or updated using a storage medium storing the program. Furthermore, the processing module may be achieved by a semiconductor chip.

The biometric authentication control unit 61 can implement the function of the biometric authentication control unit 61 by including a computer and causing the computer to execute a program. The biometric authentication control unit 61 performs a method of controlling the biometric authentication control unit 61 by the program. Similarly, the program is executed in the computer mounted on the gate device 20, whereby the method for controlling the gate device 20 is performed.

Since the basic hardware configurations of the relay unit 62 and the gate control unit 63 can be similar to those of the biometric authentication control unit 61, the description thereof will be omitted.

As illustrated in FIG. 4 and the like, the gate device 20 includes the cameras 31 and 32, the monitors 33 and 34, the detection sensors 41 to 44, and the gates 51 and 52. As in the biometric authentication control unit 61, the gate device 20 includes hardware such as a processor, a memory, and a communication interface, but illustration and description of these configurations are omitted.

The cameras 31 and 32 are camera devices capable of acquiring a visible light image. In FIG. 4, the case where the gate device 20 includes one type of cameras 31 and 32 is described, but it is not intended to limit the installation and the like of the cameras 31 and 32. For example, a plurality of cameras may be installed at the gate device 20 for each application. For example, a camera for detecting the authenticatee, a camera for tracking, and a camera for final determination of tracking may be installed at the gate device 20.

Alternatively, instead of the cameras 31 and 32 for detecting the authenticatee, the authenticatee may be detected by another means. For example, a person at a place away from the gate device 20 by a predetermined distance may be detected using a human sensor or the like. Alternatively, the camera 31 or the like may acquire image data in response to detection of a person by the human sensor, and the authenticatee may be detected.

Each of the monitors 33 and 34 is a display device such as liquid crystal monitors.

Each of the detection sensors 41 to 44 is a sensor that detects a person. As the detection sensors 41 to 44, for example, a sensor (So-called passage sensor using light) including an optical transmitting device and an optical receiving device can be used. For example, the optical transmitting device and the optical receiving device are installed to face each other (two devices are installed on an inner wall of the main body). The transmitting device constantly transmits light, and the receiving device receives the transmitted light. The gate control unit 63 determines that a person is detected when the receiving device fails to receive light. In FIG. 3 and the like, one of the two devices constituting the detection sensors 41 to 44 is illustrated.

In the above description, the configuration in which the gate device 20 includes the four detection sensors 41 to 44 is described, but some sensors may be integrated. Specifically, final tracking determination of the authenticatee and gating may be performed using an integrated detection sensor (for example, the detection sensor 41 installed at the entrance).

The gates 51 and 52 are devices that control passage of a user. The type of the gate 51 and the like is not particularly limited, and is, for example, a flapper gate in which a flapper provided from one side or both sides of the passage opens and closes, a turn coil gate in which three bars rotate, or the like.

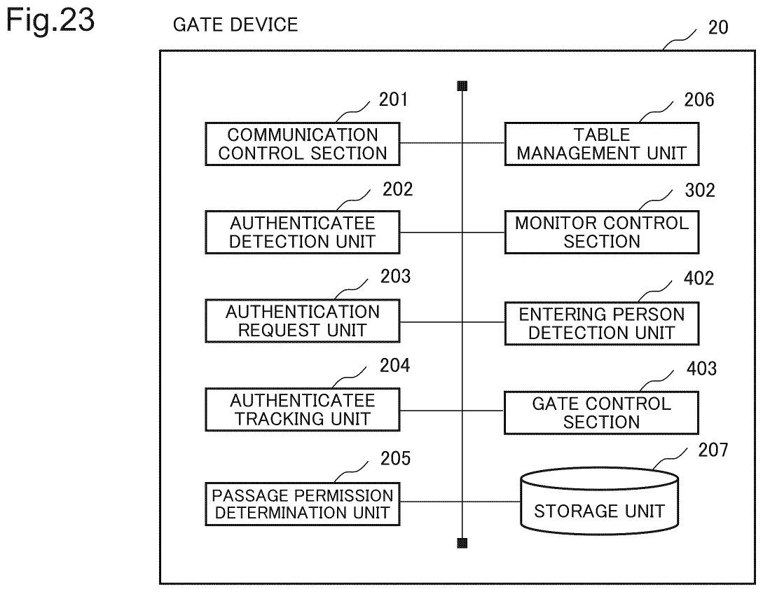

The function of the biometric authentication control unit 61 or the like may be implemented by a CPU or the like that controls the entire the gate device 20. That is, the gate device 20 may have a configuration as illustrated in FIG. 23 including each module described in the above example embodiment. Each module illustrated in FIG. 23 is denoted by the same reference numeral as each module described with reference to the drawings such as FIG. 6. Since each module can have the same processing and operation as the related module already described, the description thereof will be omitted.

Alternatively, the function of the gate device 20 may be implemented by the processor 311 included in the biometric authentication control unit 61.

The server device 10 can be configured by an information processing device. As in the biometric authentication control unit 61, the server device 10 is only required to include a processor, a memory, a communication interface, and the like, and a detailed description thereof will be omitted because a configuration thereof is obvious to those of ordinary skill.

[Modifications]

The configuration, operation, and the like of the authentication system described in the above example embodiment are merely examples, and are not intended to limit the configuration and the like of the system.

In the above example embodiment, the gate device 20 is described as a ticket gate installed in a station. However, it is needless to say that the present invention is not intended to be limited to the gate device 20 to a ticket gate. The gate device 20 may be any device that is installed in an airport, an event venue, an office, or the like and controls passage of a user.

In the above example embodiment, it is described that the monitor 33 that provides information to the user on the right side and the monitor 34 that provides information to the user on the left side are different devices. However, information may be provided to each of the right and left users using a device that can be displayed on both sides. That is, the relay unit 62 may provide information to the users on the right and left sides using one display device.

In the above example embodiment, it is described that the words (entry permitted, entry not permitted) are displayed on the monitors 33 and 34. However, a symbol, an icon, an animation, or the like may be used instead of or in addition to the words to notify the user of whether to enter the gate device 20. Alternatively, the user may be notified that entry is permitted or that entry is not permitted by a display mode of the monitors 33 and 34, such as blinking or turning off of the monitors 33 and 34.

In the above example embodiment, it is described that the biometric authentication control unit 61 detects the user in the tracking area and performs tracking in the detection area. However, the tracking may not be performed. The biometric authentication control unit 61 may request the server device 10 to perform the biometric authentication at a timing when the user reaches position X1 to transmit a biometric authentication start notification to the relay unit 62.

The biometric authentication control unit 61 may transmit the biometric authentication start notification to the relay unit 62 in response to receiving the authentication result related to the authentication success from the server device 10. In the example of FIG. 5, the biometric authentication start notification may be transmitted to the relay unit 62 at the timing when the user reaches position X2. By shifting the timing of transmitting the biometric authentication start notification in this way, passage on the other side is not meaninglessly restricted when the authentication result is “authentication failure”. That is, when the users approach the gate device 20 from both sides at the same timing, the monitors 33 and 34 are controlled in such a way as to indicate that the user on the authentication success side is permitted to pass, and the monitors 33 and 34 are controlled in such a way as to indicate that the user on the other side is not permitted to pass. As described above, in response to making a request of the server device 10 for authentication of the detected authenticatee or in response to receiving the authentication success from the server device 10, the monitors 33 and 34 may indicate that the user on the other side is not permitted to make an invasion upon the gate device.

When the biometric authentication control unit 61 detects the users from the image data acquired from each of the camera 31 for photographing the user on the right side and the camera 32 for photographing the user on the left side, a user closer to the gate device 20 may be set as the authenticatee. More specifically, the biometric authentication control unit 61 may detect the user by adopting data of an image in which the user with a longer interocular distance appears.

The biometric authentication control unit 61 may count the number of users walking toward the gate device 20 and notify the relay unit 62 of the number of users. More specifically, the biometric authentication control unit 61 calculates the approximate number of users who can be the authenticatee after transmitting the biometric authentication start notification. The approximate number of users is obtained by inputting image data to a training model prepared in advance. The relay unit 62 may display the acquired approximate number (the number of people remaining in the biometric authentication) on the monitor set to entry not permitted. With such a response, in a situation where the opposite side of the gate device 20 cannot be seen or the like, the user on the standby side can grasp the time required for standby and the like.

In the above example embodiment, the case where the server device 10 has the user information database is described. However, the database may be constructed in a database server different from that of the server device 10. The authentication system may include various means (authentication request unit 203, authenticatee tracking unit 204, and the like) described in the above example embodiment. For example, the authentication process performed by the server device 10 may be performed by the gate device 20 (biometric authentication control unit 61). Some or all of the functions of the server device 10 may be implemented by the gate device 20.

In the above example embodiment, the case where the biometric information related to the feature amount generated from the face image is transmitted from the biometric authentication control unit 61 to the server device 10 is described. However, the “face image” itself may be transmitted as the biometric information from the biometric authentication control unit 61 to the server device 10. The server device 10 may generate a feature amount from the acquired face image and perform the authentication process (one-to-N collation).

In the above example embodiment, it is assumed that the cameras 31 and 32 are monocular cameras, but the cameras 31 and 32 may be depth cameras (stereo cameras) capable of measuring the depth direction. In this case, the biometric authentication control unit 61 may detect the authenticatee at a place away from the gate device 20 by a predetermined distance using an image obtained from the stereo camera instead of the threshold value process for the interocular distance. Specifically, the biometric authentication control unit 61 analyzes two images obtained from the stereo camera (analysis using parallax), and calculates the position of the user with reference to the gate device 20. When the calculated position is included in a predetermined place, the biometric authentication control unit 61 sets the user as the authenticatee.

A form of data transmission and reception between the biometric authentication control unit 61 and the server device 10 is not particularly limited, but data transmitted and received between these devices may be encrypted. The face image and the feature amount calculated from the face image are personal information, and in order to appropriately protect the personal information, it is desirable that encrypted data be transmitted and received.

In the above example embodiment, the case where the tracking is allowed to fail until the authenticatee moves from position X1 to position X3 in FIG. 5 is described. However, the biometric authentication control unit 61 (gate device 20) may reject the authenticatee whose tracking has failed even once passing through the gate 51, 52. In this case, the biometric authentication control unit 61 may not overwrite the field in which “tracking failure” is set in the tracking status field of the authenticatee information table with “tracking in progress”. As described above, the gate device 20 can achieve more strict control (management of passersby) by rejecting the authenticatee whose tracking has failed passing through the gate.

Alternatively, the tracking process related to the movement of the authenticatee from position X1 to position X3 may not be performed. That is, the biometric authentication control unit 61 may store the face image of the authenticatee at position X1, and set the tracking result to “tracking completed” in a case where the face image captured at position X3 and the face image at position X1 are face images of the same person. As described above, the gate device 20 may omit tracking from position X1 to position X3 of the authenticatee.

Alternatively, when the tracking of the authenticatee fails a plurality of times, the entry of the authenticatee may be deleted from the authenticatee information table. The biometric authentication control unit 61 stores the number of tracking failures for each user to be tracked. The biometric authentication control unit 61 may delete the related entry when the number of tracking failures is larger than a predetermined threshold value. That is, a situation in which the tracking of the authenticatee fails a plurality of times cannot be normally assumed. In such a situation, since it is assumed that the authenticatee does not go to the gate device 20 but goes to another place, it is desirable that such an authenticatee is quickly excluded from the gate control target.

In the above example embodiment, the case where the biometric authentication control unit 61, the relay unit 62, and the gate control unit 63 are separated is described. However, these units may be integrated. That is, the biometric authentication control unit 61, the relay unit 62, and the gate control unit 63 may be integrated with the gate device 20.

In the above example embodiment, the case where the information related to the authenticatee is stored and managed using the authenticatee information table is described. However, the information related to the authenticatee may be stored and managed using a database (authenticatee information database).

In the above example embodiment, it is described that the biometric authentication control unit 61 transmits the biometric authentication start notification to the gate control unit 63 accommodated in the same gate device 20. The biometric authentication control unit 61 may transmit the biometric authentication start notification to the gate device 20 other than the gate device 20 in which the biometric authentication control unit itself is accommodated. For example, in the example of FIG. 2, the biometric authentication start notification may be transmitted from the gate device 20-1 to the gate device 20-2 and the gate device 20-3. Gate device 20 that has received the notification may grasp a state of another gate device 20 and provide information based on the grasped state. For example, consider a case where the right side of the gate device 20-1 indicates “permitted to pass”, the left side indicates “not permitted to pass”, and the right side of the gate device 20-2 indicates “permitted to pass”, and the left side indicates “not permitted to pass”. In this case, the gate device 20-2 grasps the state (right side indicates “permitted to pass” and left side indicates “not permitted to pass”) of the gate device 20-1, and displays that the user is permitted to pass through the “gate device 20-1” on the monitor on the side (right side) where passage of the (right side) is not permitted. The user of the gate device 20-2 who sees the display moves to the gate device 20-1 that the user is permitted to pass through.

Alternatively, the gate device 20 may transmit the initialization request to another gate device 20. Based on the request, the gate device 20 may grasp the state of another gate device 20 (permitted to pass in both directions). The gate device 20 may display, on a monitor on the not permitted to pass side, that the user is urged to head for the gate device 20 that the user is permitted to pass through in both directions.

In the above example embodiment, the case where the passage of the user is controlled by the gates 51 and 52 is described. However, the passage of the user may be controlled by another means without controlling the passage of the user by physical means. For example, when a user who is not qualified to passes through the gate device 20 enters the gate device 20, the passage of the user may be restricted by voice from a speaker, monitor display, or lighting or blinking of a light emitting diode (LED) or the like.

In the flow chart (flowchart and sequence diagram) used in the above description, a plurality of steps (processes) is described in order, but the execution order of the steps executed in the example embodiment is not limited to the described order. In the example embodiment, for example, the order of the illustrated steps can be changed within a range in which there is no problem in terms of content, such as executing each step in parallel.

The above example embodiments have been described in detail in order to facilitate understanding of the present disclosure, and it is not intended that all the configurations described above are necessary. In a case where a plurality of example embodiments is described, each example embodiment may be used alone or in combination. For example, part of the configuration of the example embodiment can be replaced with the configuration of another example embodiment, or the configuration of another example embodiment can be added to the configuration of the example embodiment. Furthermore, it is possible to add, delete, and replace other configurations for part of the configuration of the example embodiment.

Although the industrial applicability of the present invention is apparent from the above description, the present invention can be suitably applied to an authentication system installed in an airport, a station, or the like.

Some or all of the above example embodiments may be described as the following Supplementary Notes, but are not limited to the following.

[Supplementary Note 1]

A gate device including
an authenticatee detection unit that detects a first user at a predetermined position on one side as an authenticatee, and
a monitor control section that displays, on a monitor, that a second user on the other side is not permitted to make an invasion upon the gate device in response to making a request of a server device for authentication of the detected authenticatee or in response to receiving authentication success from the server device.

[Supplementary Note 2]

The gate device according to Supplementary Note 1, wherein the monitor control section displays, on a first monitor that is visible to the first user, that the first user is permitted to enter the gate device and displays, on a second monitor that is visible to the second user, that the second user is not permitted to enter the gate device in response to making a request of the server device for authentication of the detected authenticatee or in response to receiving authentication success from the server device.

[Supplementary Note 3]

The gate device according to Supplementary Note 2, wherein the monitor control section displays, on the first monitor and the second monitor, that users on the one side and the other side are permitted to enter the gate device when no person is present inside the gate device.

[Supplementary Note 4]

The gate device according to any one of Supplementary Notes 1 to 3, further including
a tracking unit that tracks the detected authenticatee, and
a determination unit that determines whether the authenticatee is permitted to pass through the gate device based on a result of biometric authentication of the authenticatee by the server device and a result of a tracking determination of the authenticatee at an entrance of the gate device.

[Supplementary Note 5]

The gate device according to any one of Supplementary Notes 1 to 4, wherein the authenticatee detection unit detects the authenticatee based on an interocular distance calculated from a face image included in data of an image captured at the predetermined position.

[Supplementary Note 6]

The gate device according to any one of Supplementary Note 4, wherein the tracking unit starts tracking the authenticatee at a same time as the server device is requested to authenticate the authenticatee.

[Supplementary Note 7]

A biometric authentication control unit including
an authenticatee detection unit that detects a first user at a predetermined position on one side as an authenticatee, and
a request unit that makes a request of a server device that performs biometric authentication for authentication of the detected authenticatee, wherein
the authenticatee detection unit
transmits a biometric authentication start notification to a gate control unit via a relay unit in response to the biometric authentication being requested, and wherein
the relay unit controls a first monitor and a second monitor installed at the gate device.

[Supplementary Note 8]

The biometric authentication control unit according to Supplementary Note 7, wherein in response to the relay unit receiving the biometric authentication start notification, the first monitor displays that the first user is permitted to enter the gate device, and the second monitor displays that a second user on the other side is not permitted to make an invasion upon the gate device.

[Supplementary Note 9]

The biometric authentication control unit according to Supplementary Note 8, further including
a tracking unit that tracks the detected authenticatee, and
a determination unit that determines whether the authenticatee is permitted to pass through the gate device based on a result of biometric authentication of the authenticatee by the server device and a result of a tracking determination of the authenticatee at an entrance of the gate device, wherein
the tracking unit makes a final determination related to tracking of the authenticatee in response to receiving, from the gate control unit, a user detection notification indicating that a user is detected at an entrance of the gate device, and wherein
the determination unit determines whether the authenticatee is permitted to pass through the gate device based on a result of the biometric authentication and a result of the final determination, and notifies the gate control unit via the relay unit of a determination result.

[Supplementary Note 10]

The biometric authentication control unit according to Supplementary Note 9, wherein the determination unit transmits a passage permission notification to the gate control unit via the relay unit when determining that the authenticatee is permitted to pass through the gate device.

[Supplementary Note 11]

A system including
a server device that performs biometric authentication, and
a gate device connected to the server device, wherein
the gate device includes
an authenticatee detection unit that detects a first user at a predetermined position on one side as an authenticatee, and
a monitor control section that displays, on a monitor, that a second user on the other side is not permitted to make an invasion upon the gate device in response to making a request of the server device for authentication of the detected authenticatee or in response to receiving authentication success from the server device.

[Supplementary Note 12]

A method of controlling a gate device, the method including
the gate device
detecting a first user at a predetermined position on one side as an authenticatee, and
displaying, on a monitor, that a second user on the other side is not permitted to make an invasion upon the gate device in response to making a request of a server device for authentication of the detected authenticatee or in response to receiving authentication success from the server device.

[Supplementary Note 13]

A non-transitory computer-readable storage medium storing a program for causing a computer mounted on a gate device to execute the steps of
detecting a first user at a predetermined position on one side as an authenticatee, and
displaying, on a monitor, that a second user on the other side is not permitted to make an invasion upon the gate device in response to making a request of a server device for authentication of the detected authenticatee or in response to receiving authentication success from the server device.

The disclosures of the cited prior art documents are incorporated herein by reference. While the exemplary example embodiments of the present invention have been described, the present invention is not limited to these example embodiments. It will be understood by those of ordinary skill in the art that these example embodiments are exemplary only and that various variations may be made therein without departing from the scope and spirit of the present invention as defined by the claims. That is, it goes without saying that the present invention includes various modifications and corrections that can be made by those of ordinary skill in the art in accordance with the entire disclosure including the claims and the technical idea.

### REFERENCE SIGNS LIST

10 server device
20, 20-1 to 20-3, 100 gate device
31, 32 camera
33, 34 monitor
41 to 44 detection sensor
51, 52 gate
61, 61a, 61b biometric authentication control unit
62 relay unit
63 gate control unit
70 to 73 user
101, 202 authenticatee detection unit
102, 302 monitor control section
201, 301, 401, 501 communication control section
203 authentication request unit
204 authenticatee tracking unit
205 passage permission determination unit
206 table management unit
207, 303, 404, 505 storage unit
311 processor
312 memory
313 communication interface
402 entering person detection unit
403 gate control section
502 user registration unit
503 authentication unit
504 gate passage notification processing unit

What is claimed is:

1. A gate device comprising:
one or more memories storing instructions; and
one or more processors configured to execute the instructions to:
detect a first user at a predetermined position on one side as an authenticatee; and
display, on a monitor, that a second user on the other side is not permitted to enter the gate device in response to making a request of a server device for authentication of the detected authenticatee or in response to receiving authentication success from the server device.

2. The gate device according to claim 1,
wherein the one or more processors are configured to execute the instructions to display, on a first monitor that is visible to the first user, that the first user is permitted to enter the gate device; and
display, on a second monitor that is visible to the second user, that the second user is not permitted to enter the gate device,
in response to making a request of the server device for authentication of the detected authenticatee or in response to receiving authentication success from the server device.

3. The gate device according to claim 2,
wherein the one or more processors are configured to execute the instructions to display, on the first monitor and the second monitor, that users on the one side and the other side are permitted to enter the gate device when no person is present inside the gate device.

4. The gate device according to claim 1,
wherein the one or more processors are further configured to execute the instructions to track the detected authenticatee; and
determine whether the authenticatee is permitted to pass through the gate device based on a result of biometric authentication of the authenticatee by the server device and a result of a tracking determination of the authenticatee at an entrance of the gate device.

5. The gate device according to claim 1,
wherein the one or more processors are configured to execute the instructions to detect the authenticatee based on an interocular distance calculated from a face image included in data of an image captured at the predetermined position.

6. The gate device according to claim 4,
wherein the one or more processors are configured to execute the instructions to start tracking the authenticatee at a same time as the server device is requested to authenticate the authenticatee.

7. (canceled)

8. (canceled)

9. (canceled)

10. (canceled)

11. (canceled)

12. A method of controlling a gate device, the method comprising:
by a computer,
detecting a first user at a predetermined position on one side as an authenticatee; and
displaying, on a monitor, that a second user on the other side is not permitted to enter the gate device in response to making a request of a server device for authentication of the detected authenticatee or in response to receiving authentication success from the server device.

13. A non-transitory computer-readable medium storing a program for causing a computer mounted on a gate device to execute the steps of:
detecting a first user at a predetermined position on one side as an authenticatee; and
displaying, on a monitor, that a second user on the other side is not permitted to enter the gate device in response to making a request of a server device for authentication of the detected authenticatee or in response to receiving authentication success from the server device.

14. The gate device according to claim 2,
wherein the one or more processors are further configured to execute the instructions to track the detected authenticatee; and
determine whether the authenticatee is permitted to pass through the gate device based on a result of biometric authentication of the authenticatee by the server device and a result of a tracking determination of the authenticatee at an entrance of the gate device.

15. The gate device according to claim 3,
wherein the one or more processors are further configured to execute the instructions to track the detected authenticatee; and
determine whether the authenticatee is permitted to pass through the gate device based on a result of biometric authentication of the authenticatee by the server device and a result of a tracking determination of the authenticatee at an entrance of the gate device.

16. The gate device according to claim 2,
wherein the one or more processors are configured to execute the instructions to detect the authenticatee based on an interocular distance calculated from a face image included in data of an image captured at the predetermined position.

17. The gate device according to claim 3,
wherein the one or more processors are configured to execute the instructions to detect the authenticatee based on an interocular distance calculated from a face image included in data of an image captured at the predetermined position.

18. The gate device according to claim 4,
wherein the one or more processors are configured to execute the instructions to detect the authenticatee based on an interocular distance calculated from a face image included in data of an image captured at the predetermined position.

19. The gate device according to claim 14,
wherein the one or more processors are configured to execute the instructions to detect the authenticatee based on an interocular distance calculated from a face image included in data of an image captured at the predetermined position.

20. The gate device according to claim 15,
wherein the one or more processors are configured to execute the instructions to detect the authenticatee based on an interocular distance calculated from a face image included in data of an image captured at the predetermined position.
